(19) United States
(12) Patent Application Publication
(10) Pub. No.: US 2023/0111586 A1
(43) Pub. Date: Apr. 13, 2023

(54) CONSUMABLE FOR ANALYTE DETECTION

(71) Applicants: BIO-RAD LABORATORIES, INC., Hercules, CA (US); ALIGHT SCIENCES INC., Ann Arbor, MI (US)

(72) Inventors: WILLIAM BRADLEY STRONG, EL CERRITO, CA (US); ALEXANDER EDMUND JOHNSON-BUCK, ANN ARBOR, MI (US)

(21) Appl. No.: 17/964,071

(22) Filed: Oct. 12, 2022

Related U.S. Application Data
(60) Provisional application No. 63/254,704, filed on Oct. 12, 2021.
(60) Provisional application No. 63/293,102, filed on Dec. 23, 2021.

(51) Int. Cl. B01L 3/00; G01N 21/64

(52) U.S. Cl. CPC B01L 3/502715; G01N 21/6428; G01N 2021/6439; B01L 2300/0829; B01L 2300/161; B01L 2300/168

(57) ABSTRACT

This disclosure pertains to a consumable product (microplate) suitable for use in assays utilizing single-molecule recognition through equilibrium Poisson sampling (SiMREPS) and in other assays employing total internal reflection fluorescence (TIRF) or HiLo microscopy. The disclosed microplate is also suitable for use in other high throughput assay systems, such as single-molecule FRET, ligand-receptor binding studies, membrane biology assays, cell-based TIRF and near-TIRF assays. The disclosure further pertains to the use of the microfluidic microplate for the detection of analytes, including nucleic acids, polypeptides, carbohydrates, lipids, post-translational modifications, amino acids, metabolites, and small molecules.

### CROSS-REFERENCE TO RELATED APPLICATIONS

This application claims the benefit of U.S. Provisional Application Nos. 63/254,704, filed Oct. 12, 2021, and 63/293,102, filed Dec. 23, 2021, which are hereby incorporated by reference in their entirety.

### BRIEF DESCRIPTION

This disclosure pertains to a consumable product (microplate) suitable for use in assays utilizing single-molecule recognition through equilibrium Poisson sampling (SiMREPS) and in other assays employing total internal reflection fluorescence (TIRF) or HiLo microscopy. The disclosed microplate is also suitable for use in other high throughput assay systems, such as single-molecule FRET, ligand-receptor binding studies, membrane biology assays, cell-based TIRF and near-TIRF assays.

In one embodiment, the product is a microplate that comprises three layers, a top layer (Layer 1) comprising a plurality of wells on the top face of the layer and which have an opening that is fluidly connected to microfluidic channels that are integrated into the lower portion of the top layer or the upper layer or surface of a middle layer (Layer 2), and a third layer (Layer 3) that comprises a prism. In another embodiment, the microplate comprises two layers, a top layer (Layer 1) that comprises a plurality of wells on the top face of the layer, each well having an opening that is fluidly connected to microfluidic channels that are integrated into the lower portion of the top layer or the upper layer or upper surface of the second layer (Layer 2) that comprises a planar surface comprising the imaging zones and the prism. In another embodiment, Layer 2 lacks the prism and the layer comprises a high refractive index material suitable for use as a waveguide in waveguide TIRF or Layer 2 is a composite material that integrates a waveguide comprising high refractive index materials upon which the imaging zones are deposited. In various embodiments, an exit port can be provided in Layer 1, Layer 2, or both Layer 1 and Layer 2.

The product resembles a microplate having, for example, a well pitch in at least one dimension of 96, 384, or 1536 well formats. The microplates can have a well pitch that is the same in two dimensions or that differs in two dimensions. For example, a well pitch for a 96 well format in one dimension and a well pitch for a 384 well format in a second dimension. As would be apparent, any desired well pitch can be used for the well format of the microplates. Channels exiting from the bottom of a plurality of wells, for example 8 wells in a 96 well format product, bundle into a central imaging zone and exit through an opening in the imaging zone. The imaging zone is functionalized such that ligands that bind to a particular analyte are a localized to the imaging zone for the purposes of the SiMREPS or other surface-based TIRF microscopy assays.

The disclosure further pertains to the use of the microfluidic microplate for detection of analytes, including, for example, biomolecules (e.g., nucleic acids (e.g., DNA, RNA, nucleic acids comprising methylated and other modified or non-naturally occurring nucleobases and/or nucleotides), polypeptides (e.g., peptides, proteins, glycoproteins), carbohydrates, lipids, post-translational modifications, amino acids, metabolites, and small molecules and systems comprising the disclosed microfluidic microplates.

### BRIEF DESCRIPTION OF DRAWINGS

FIGS. 1A-1C show an embodiment of the present disclosure wherein an array of 96 wells formed in the top surface of Layer 1. Each well is connected via a through hole to a corresponding 1 of 96 individual microchannels formed in the bottom surface of Layer 1. Each column of 8 wells bundles into a single central imaging zone. The well lengths are shown as linear lines in this FIGURE, but can adopt any configuration. In some embodiments, the microchannel length for each well is equal to permit for a uniform sample flow rate from each well.

FIG. 2 shows an exploded view of an embodiment of the present disclosure. This figure illustrates well structure and microchannel structure in Layer 1, Layer 2 (in which functionalized regions are located in a central location at which microchannels from each well converge (bundle), and Layer 3 (the prism used for prism TIRF). Guide holes can be present in Layers 1 and 2 to permit the alignment of the prism with Layers 1 and 2. Solid alignment pins are shown protruding from the prism in this FIGURE, but other alignment mechanisms are contemplated.

FIGS. 3A-3C illustrate the optics configuration for prism-TIRF SiMREPS assays utilizing the disclosed consumable product. The laser is configured to illuminate the imaging zone and detection of the analyte is performed by a device comprising a large field of view (FOV) objective lens, such as an objective lens having a FOV diameter of about 0.5 mm, about 1.0 to about 5.0 mm, about 1.0 mm to about 3.0 mm, or about 1.5 mm to about 2 mm.

FIGS. 4A-4B show an embodiment of the present disclosure in which samples are loaded into all the wells and are then drawn to a central imaging zone.

FIGS. 4C1-4C2 show a simplified representation of a single well, via, channel in Layer 1, a first vacuum portal in Layer 2, and a second vacuum portal in the prism. A vacuum is applied to the port at the bottom of the prism (FIG. 4C2) to initiate flow from each respective well. The port can be connected to a vacuum source and/or reservoirs for reagents, waste or washing buffers.

FIGS. 5A-5B show a different embodiment in which a 96 well plate is analyzed. The imaging zone contains 4 preprinted antibody capture zones (indicated as (1), (2), (3), and (4)) for the multiplex analysis of the sample. Microchannels leading from wells to the antibody capture zones are also depicted in detail (FIG. 5B).

FIGS. 6A-6C. FIG. 6A (top view) shows an embodiment of a two layer microplate in which Layer 2 contains a prism. The imaging zones are deposited on Layer 2 (FIGS. 6B (top view) and 6C (side view)).

### DETAILED DESCRIPTION

It is to be appreciated by those skilled in the art that modification or variation may be made to the preferred embodiments of the present disclosure, as described herein, without departing from the essential novelty of this present disclosure. All such modifications and variations are intended to be incorporated herein and are within the scope of this disclosure.

As used herein, the singular forms “a”, “an” and “the” are intended to include the plural forms as well, unless the context clearly indicates otherwise. Furthermore, to the extent that the terms “including”, “includes”, “having”, “has”, “with”, or grammatical variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The term “about” or “approximately” means a range of up to 0-20%, 0 to 10%, 0 to 5%, or up to 1% of a given value. In certain embodiments, the terms refer to a 10% variation around a given value (e.g., X±10%). In the present disclosure, ranges are stated in shorthand, so as to avoid having to set out at length and describe each and every value within the range. Any appropriate value within the range can be selected, where appropriate, as the upper value, lower value, or the terminus of the range. For example, a. range of 0.1-1.0 represents the terminal values of 0,1 and 1.0, as well as the intermediate values of 0,2, 0,3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values.

As used herein, the term “nucleic acid” or “polynucleotide” refers to deoxyribonucleic acids (DNA) or ribonucleic acids (RNA) and polymers thereof in either single- or double-stranded form. Unless specifically limited, the term encompasses nucleic acids containing known analogs of natural nucleotides that have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions), alleles, orthologs, single nucleotide polymorphisms (SNPs), and complementary sequences as well as the sequence explicitly indicated. Specifically, degenerate codon substitutions may be achieved by generating sequences in which the third position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); and Rossolini et al., Mol. Cell. Probes 8:91-98 (1994)). The term nucleic acid is used interchangeably with gene, cDNA, and mRNA encoded by a gene. As used herein, the phrase “hybridizes with” when used with respect to two sequences indicates that the two sequences are sufficiently complementary to each other to allow nucleotide base pairing between the two sequences. Sequences that hybridize with each other can be perfectly complementary but can also have mismatches to a certain extent. Depending upon the stringency of hybridization, a mismatch of up to about 5% to 20% between the two complementary sequences would allow for hybridization between the two sequences. Typically, high stringency conditions have higher temperature and lower salt concentration and low stringency conditions have lower temperature and higher salt concentration. High stringency conditions for hybridization are preferred.

In this application, the terms “polypeptide”, “peptide”, and “protein” are used interchangeably herein to refer to a polymer of amino acids. The terms apply to amino acid polymers in which one or more amino acid residues are artificial chemical mimetics of corresponding naturally occurring amino acids, as well as to naturally occurring amino acid polymers and non-naturally occurring amino acid polymers, including those comprising post-translational modifications. As used herein, the terms encompass amino acid chains of any length, including full-length proteins, wherein the amino acid residues are linked by covalent peptide bonds, as well as multi-subunit proteins wherein two or more covalently linked chains of amino acids are associated by covalent bonds or non-covalent interactions.

As used herein, the terms “identical” or percent “identity”, in the context of describing two or more polynucleotide or amino acid sequences, refer to two or more sequences or subsequences that are the same or have a specified percentage of amino acid residues or nucleotides that are the same (for example, a variant protein used in the method of this invention has at least 80% sequence identity, preferably 85%, 90%, 91%, 92%, 93, 94%, 95%, 96%, 97%, 98%, 99%, or 100% identity, to a reference sequence), when compared and aligned for maximum correspondence over a comparison window, or designated region as measured using one of the following sequence comparison algorithms or by manual alignment and visual inspection. Such sequences are then said to be “substantially identical”. With regard to polynucleotide sequences, this definition also refers to the complement of a sample sequence. The comparison window, in certain embodiments, refers to the full-length sequence of a given mRNA sequence or polypeptide.

As used herein, “complementary,” in the context of describing two or more polynucleotide sequences, refers to one sequence or subsequences that is at least 60%, 65%, 70%, 75%, 80%, 85%, 90%, 95%, 97%, 98%, or 99% identical to the complement of a second nucleotide sequence over a region of 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, or more nucleobases, or that the two sequences hybridize under stringent hybridization conditions. “Fully complementary” or “entirely complementary” refers to a first nucleotide sequence that is 100% identical to the complement of a second nucleic acid.

As used herein, the term “sample” is used in its broadest sense. In some embodiments, a sample is or comprises an animal cell or tissue. In some embodiments, a sample includes a specimen or a culture (e.g., a microbiological culture) obtained from any source, as well as biological and environmental samples. Biological samples may be obtained from plants or animals (including humans) and encompass fluids, solids, tissues, and gases. Environmental samples include environmental material such as surface matter, soil, water, and industrial samples. These examples are not to be construed as limiting the sample types applicable to the present technology.

As used herein, the phrases “biological sample” or “sample from a subject” encompasses a variety of sample types obtained from an organism. The term encompasses bodily fluids such as blood, blood components, saliva, nasal mucous, serum, plasma, cerebrospinal fluid (CSF), urine and other liquid samples of biological origin, solid tissue biopsy, tumor, tissue cultures, or supernatant taken from cultured patient cells. The sample can further be obtained from environmental sources. Environmental samples include environmental material such as surface matter, soil, air, water, and industrial samples. The biological sample can be processed prior to assay, such as, for example, washed. The term encompasses samples that have been manipulated after their procurement, such as by treatment with reagents, solubilization, sedimentation, or enrichment for certain components.

As used herein, “subject,” “patient,” “individual” and grammatical equivalents thereof are used interchangeably and refer to, mammals, such as, for example, humans and non-human primates, rabbits, felines, canines, rats, mice, squirrels, goats, pigs, and deer or non-mammalian species, particularly organisms used as model organisms for research purposes, including, for example, Zebrafish, Xenopus spp., Drosophila spp., and Caenorhabditis spp., including, for example, C. elegans. The term does not necessarily indicate that the subject has been diagnosed with a particular disease, but typically refers to an individual under medical or veterinary supervision. A patient can be an individual that is seeking treatment, monitoring, adjustment or modification of an existing therapeutic regimen.

As used herein, the term “immobilized” denotes a molecular-based coupling that is not significantly de-coupled (i.e., is irreversible or only reversible on timescales longer than the length of a typical measurement) under the conditions imposed during the steps of the assays described herein. Such immobilization can be achieved through a covalent bond, a non-covalent bond, an ionic bond, an affinity interaction (e.g., avidin-biotin or polyhistidine-Nr⁺⁺), or any other chemical bond.

The terms “label,” “detectable label,” “detectable moiety,” and like terms refer to a composition detectable by spectroscopic, photochemical, biochemical, immunochemical, chemical, or other physical means. For example, useful labels include fluorescent dyes (fluorophores), luminescent agents, electron-dense reagents, enzymes (e.g., as commonly used in an ELISA), biotin, enzymes acting on a substrate (e.g., horseradish peroxidase), digoxigenin, ³²P and other isotopes, haptens, and proteins which can be made detectable, e.g., by incorporating a radiolabel into the peptide or used to detect antibodies specifically reactive with the peptide. The term includes combinations of single labeling agents, e.g., a combination of fluorophores that provides a unique detectable signature, e.g., at a particular wavelength or combination of wavelengths. Any method known in the art for conjugating label to a desired agent may be employed, e.g., using methods described in Hermanson, Bioconjugate Techniques 1996, Academic Press, Inc., San Diego.

As used herein, the phrases “equilibrium constant” (K_{eg}), the “equilibrium association constant” (Kₐ), and “association binding constant” (or “binding constant” (K_{B})) can be used interchangeably for the following binding reaction of A and B at equilibrium:

$$\begin{matrix}A + B \\ ⇌ \\ AB\end{matrix}$$

where A and B are two entities that associate with each other, such as, for example, capture probe and analyte, query probe and analyte, and K_{eq}=Kₐ=K_{B}=[AB]/([A]×[B]). The dissociation constant can be represented as K_{D}=1/K_{B}. The K_{D} can be a useful way to describe the affinity of a one binding partner A for a partner B with which it associates, such as, for example, the number K_{D} represents the concentration of A or B that is required to yield a significant amount of AB. Accordingly, the dissociation constant, K_{D}, and the association constant, K_{A}, are quantitative measures of affinity. At equilibrium, A and B are in equilibrium with A-B complex, and the rate constants, kₐ and k_{d}, quantify the rates of the individual forward and backward reactions of the equilibrium state:

$$A - B \begin{matrix}{k}_{a} \\ ⇌ \\ {k}_{d}\end{matrix} AB$$

At equilibrium, kₐ[A] [B]=k_{d}[AB]. Furthermore, the equilibrium constants are related to kinetic rate constants of binding (kₐ) and dissociation (k_{d}) as K_{eq}=kₐ/k_{d} and K_{D}=k_{d}/kₐ. The rate constant kₐ can alternatively be written kₒₙ or k_{bind}, and the rate constant ka can be written as k_{off} or k_{dissoc}. The dissociation constant, K_{D}, is given by K_{D}=k_{d}/kₐ=[A] [B]/[AB]. K_{D} has units of concentration, e.g., M, mM, μM, nM, pM, etc. When comparing affinities expressed as K_{D}, a greater affinity is indicated by a lower value. The association constant, K_{A}, is given by K_{A}=1/K_{D}=[AB]/[A] [B]. K_{A} has units of inverse concentration, most typically M⁻¹, mM⁻¹, μM⁻¹, nM⁻¹, etc.

The microplate disclosed herein can be used in a system that comprises a detection component (for example, a prism-type total internal reflection fluorescence (TIRF) detection system comprising an illumination configuration (e.g., a laser) to excite bound detection agents) and, optionally, a component suitable for heating (a heating component) the microplate (for example, a heating block or other support that can regulate the temperature of the microplate, for example, assay temperatures between individual samples at 25° C. or 30° C. or 37° C.). Other embodiments utilize a device comprising a laser, a fluorescence detector, such as a detector comprising an charge coupled device (CCD), an intensified charge coupled device (ICCD), an electron-multiplying charge coupled device (EM-CCD), a complementary metal oxide semiconductor (CMOS) and/or another detector capable of detecting fluorescence emission from single chromophores and elements that permit the introduction/automation of reagent delivery (e.g., samples, binding agents, detecting agents, wash buffers, waste reservoirs, etc.). In various embodiments, the detector comprises an objective lens having a FOV diameter of about 0.1 mm, about 0.2 mm, about 0.3 mm, about 0.4 mm, about 0.5 mm, about 0.1 mm to about 1.0 mm, about 0.1 mm to about 5.0 mm, about 0.1 mm to about 2.5 mm, about 0.1 mm to about 2 mm, about 0.25 mm to about 0.75 mm, about 0.5 mm to about 5.0 mm, about 1.0 mm to about 5.0 mm, about 1.0 mm to about 3.0 mm, or about 1.5 mm to about 2 mm.

Unless otherwise explicitly described, the microplate disclosed herein comprises two or three layers. In the configuration comprising three layers, the top layer (Layer 1) comprises a plurality of wells on the top face of the layer, each well having an opening that is fluidly connected to microfluidic channels (also referred to as microchannels) that are integrated into the lower portion of the top layer or the upper layer or upper surface of a middle layer (Layer 2), and a third later (Layer 3) that comprises a prism. Two or more of the microchannels converge on (or bundle into) an imaging zone found on the upper surface second layer of the microplate and, thus, fluidly connect each well with the imaging zone. In various embodiments, an exit port can be provided on/in one or more of Layer 1, Layer 2 and Layer 3.

In the configuration comprising two layers, the microplate comprises a top layer (Layer 1) that comprises a plurality of wells on the top face of the layer, each well having an opening that is fluidly connected to microfluidic channels that are integrated into the lower portion of the top layer or the upper layer or upper surface of the second layer (Layer 2) that comprises a planar surface comprising the imaging zones and the prism. As discussed above, Layer 2 (in some embodiments) can be constructed such that the entire layer comprises a high refractive index material suitable for use as a waveguide in waveguide TIRF (for example, polymethylmethacrylate (PMMA) clad with fluorinated polymer, such as CYTOP or a high refractive index material such as silicon nitride or tantalum pentoxide, cyclic olefin polymer (COP) and/or cyclic olefin copolymer (COC)) and the prism aspect (Layer 3) can be omitted. In some embodiments, Layer 2 can be a composite material that integrates a waveguide comprising high refractive index materials upon which the imaging zones are deposited which is then integrated into other Layer 2 materials, such as plastics or other materials that can surround the waveguide material. One or more exit port can be provided in the waveguide material used to support the imaging zones or other areas of Layer 2 provided to which the exit port(s) and imaging zones are fluidly connected. Alternatively, one or more exit port that is fluidly connected to the imaging zones can be provided in Layer 1. For example, the exit port provided in Layer 1 can include a valve (e.g., a one-way valve) to permit removal of fluids from the imaging zone. Various materials suitable for waveguide TIRF are known to those skilled in the art, see for example, Archetti, A., Glushkov, E., Sieben, C. et al. Waveguide-PAINT offers an open platform for large field-of-view super-resolution imaging. Nat Commun 10, 1267 (2019). see: doi.org/10.1038/s41467-019-09247-1; H. M. Grandin et al, Waveguide excitation fluorescence microscopy: A new tool for sensing and imaging the biointerface Biosensors and Bioelectronics 21 (2006) 1476-1482; Paul I. Okagbare, et al. Fabrication of a cyclic olefin copolymer planar waveguide embedded in a multi-channel poly(methyl methacrylate) fluidic chip for evanescence excitation. Lab Chip. 2010. 10(1): 66-73; and U.S. Pat. No. 9,212,995 (each of which is hereby incorporated by reference in its entirety).

A “microfluidic device” or “microplate” or “microfluidic microplate”, as used herein, is a device that enables a means of effecting a deterministic function on fluids at small scales typically measured in volumes such as, for example, milliliter (mL), microliter (μL), nanoliter (nL), picoliter (pL), or femtoliter (fL) volumes and/or by physical scale such as millimeter (mm), micrometer (μm) (also referred to as “micron”), nanometer (nm), and so forth. These terms can be used interchangeably throughout the present disclosure.

The disclosed microplate provides a fluidics network which is an assembly for manipulating fluid, generally by transferring fluid between compartments of the assembly (e.g., the wells, imaging zone, and waste reservoirs by driving flow of fluid along and/or through one or more of the channels defining the assembly. A fluidics network may include any suitable structure, such as one or more channels, chambers, reservoirs, valves, pumps, thermal control devices (e.g., heaters/coolers), sensors (e.g., for measuring temperature, pressure, flow, etc.), or any combination thereof. In some embodiments, the imaging zones can be provided with a thermal control device that regulates the temperature in the imaging zone where an assay is being performed (for example, at 25° C., 30° C., or 37° C.). In some embodiments, the temperature for each imaging zone can be independently regulated.

The terms “microchannel” and “microfluidic channel” and “channel” all refer to the same fluidic structure unless otherwise dictated by the context. The term “interface hole” or “through hole” or “via hole” all refer to the same structure connecting the well structure to the microchannel structure unless dictated otherwise by the context. The terms “fluidly connected” and “fluid connection” refer to a microchannel that connects an individual well with a particular imaging zone where the contents of the well are deposited for analysis.

A channel may include walls that define and enclose the passage between the well and the imaging zone. A channel may, for example, be formed by a tube (e.g., a capillary tube), in or on a planar structure (e.g., a chip or layer as disclosed herein), or a combination thereof, among others. A channel may or may not branch. A channel may be linear or nonlinear. Exemplary nonlinear channels include a channel extending along a planar flow path (e.g., a serpentine channel) a nonplanar flow path (e.g., a helical channel to provide a helical flow path). Any of the channels disclosed herein may be a microfluidic channel, which is a channel having a characteristic transverse dimension (e.g., the channel's average diameter) of less than about one millimeter.

Channels disclosed herein can be treated with a variety of compounds to restrict the flow of liquids in the absence of pressure (e.g., a vacuum) or the channels can be constricted to prevent sample flow from a well. For example, the microchannels can be constructed from (or coated with) a hydrophobic material, such as polytetrafluoroethylene (PTFE), silanes having one or more hydrocarbon group (for example, a C8-C36 alkyl group, aryl group, or combination thereof), fluorinated ethylene propylene (FEP), or perfluoroalkoxy (PFA). The microchannels can be coated with the hydrophobic materials using techniques such as vacuum deposition, spin coating, or vapor deposition. Microchannels can, optionally, be vented to facilitate the movement of liquid from a well into the microchannels and/or imaging zone. In some embodiments, the imaging zone (instead of the microchannels) can be vented to permit such movement of liquid through the microchannels. In other embodiments, both the microchannels and the imaging zone can be vented to facilitate movement of liquids from the wells to the imaging zone. In other embodiments, the channels can be passivated to reduce binding of certain reagents like proteins or nucleic acids. Covalent passivation can be performed using silyl-PEGs (silyl-polyethylene glycols) or reactive PEGs as an example, hydrophobic silanes such as dimethyldichlorosilane (DDS) followed by introduction an amphiphilic compound such as polysorbate 20 (TWEEN 20). In addition, or alternatively, microchannels can be non-covalently passivated using BSA, synthetic, plant or other blocking agents or substances that are known in the art (see, for example, Hua, B., Han, K., Zhou, R. et al. An improved surface passivation method for single-molecule studies. Nat Methods 11, 1233-1236 (2014). see: doi.org/10.1038/nmeth.3143, the disclosure of which is hereby incorporated by reference in its entirety).

In other embodiments, the wells and channels can be passivated with hydrophilic agents. Such chemical modifications can create water wetting surfaces that have high surface energy, which can draw sample fluids to the central imaging zone via capillary forces. Non-limiting examples of hydrophilic agents include: polyethylene glycol (PEG), polyacrylamide, poly(vinyl alcohol) (PVA), hydroxylethylcellulose (HEC), poly(N-hydroxyethyl acrylamide) (PHEA), hydroxylpropyl methylcellulse (HPMC), poly(-hydroxyethyl methacrylate) (pHEMA), poly(vinyl pyrrolidone) (PVP), poly(acrylic acid) (PAA), dextran, hyaluronic acid, and poly(-methacryloyloxyethyl phosphorylcholine) (PMPC).

After a desired incubation time, fluid in the imaging zone can be removed by the application of pressure or a vacuum where it exits via a port found in the central imaging zone. The exit port can be localized at the end of the central imaging zone, near each individual imaging zone present on the microplate, a plurality of exit ports can be dispersed throughout the central imaging zone to facilitate removal of fluid or the exit port(s) are fluidly connected to a port in the prims that can provide for fluid exit through the port in the prism or another port located in Layer 2. Exit ports may include a valve such as a one-way valve or pressure-sensitive valve to prevent back-flow of solutions from the waste to the imaging zone. In some embodiments, the exit port can be provided in Layer 1 and can include a valve (e.g., a one-way valve) to permit removal of fluids from the imaging zone. The central imaging zone can be centrally located in the microfluidic microplate as illustrated in the Figures or offset to a side of the microfluidic microplate. In preferred embodiments, the imaging zones are linearly arranged to facilitate movement of the plate over a fixed objective on a detection device in the X or Y axis.

The term “well” is used to describe a functional unit of the microfluidic microplate wherein the microfluidic microplate contains multiple essentially identical “wells” that comprise the entire microplate.

“Biotin”, a 244 Dalton vitamin found in tiny amounts in all living cells, binds with high affinity to avidin, streptavidin and NEUTRAVIDIN proteins. Since biotin is a relatively small molecule, it can be conjugated to many proteins without significantly altering their biological activity. A protein can be reacted with several molecules of biotin that, in turn, can each bind a molecule of avidin. This greatly increases the sensitivity of many assay procedures.

“Avidin” is a glycoprotein found in the egg white and tissues of birds, reptiles and amphibians. It contains four identical subunits having a combined mass of 67,000-68,000 Daltons. Each subunit consists of 128 amino acids and binds one molecule of biotin. Another biotin-binding protein is “streptavidin”, which is isolated from Streptomyces avidinii and has a mass of 75,000 Daltons. In contrast to avidin, streptavidin has no carbohydrate and has a mildly acidic pl (5.5). “Neutravidin”™ is a deglycosylated version of avidin, with a mass of approximately 60,000 Daltons. The terms avidin, streptavidin and (strept)avidin are used interchangeably herein. Avidin, streptavidin and (strept)avidin can be functionalized and bound to the surface of an imaging zone as disclosed herein to facilitate the deposition of a capture ligand to the surface of the imaging zone. For example, the imaging zone can be functionalized with an agent to permit attachment of a binding agent to the surface of the imaging zone.

The assays and methods described herein can be used to detect one or more analytes in any type of sample. In some embodiments, the sample is a biological sample, a chemical sample or a physical sample. Biological samples can be obtained from any biological organism, e.g., an animal, plant, fungus, bacterial, viruses or prions or any other organism or the sample itself is an organism. In some embodiments, the biological sample is from an animal, e.g., a mammal (e.g., a human or a non-human primate, a cow, horse, pig, sheep, cat, dog, mouse, or rat), a bird (e.g., chicken), or a fish. A biological sample can be any tissue or bodily fluid obtained from the biological organism, e.g., blood, a blood fraction, or a blood product (e.g., serum, plasma, platelets, red blood cells, and the like), sputum or saliva, cerebrospinal fluid (CSF), tissue (e.g., kidney, lung, liver, heart, brain, nervous tissue, thyroid, eye, skeletal muscle, cartilage, or bone tissue); sample obtained through a biopsy procedure, cancer cell, cultured cells, e.g., primary cultures, explants, transformed cells, stem cells, cell secretions, stool, or urine. Biological samples can also be derived from fixed (e.g., FFPE), preserved, or archived samples.

In some embodiments, the one or more analytes to be detected are peptides, proteins (e.g., antibodies, enzymes, hormones, interleukins, chemokines, growth regulators, clotting factors, or phosphoproteins), fatty acids, small molecules, lipids, carbohydrates, glycolipids, sphingolipids, organic molecules, inorganic molecules, cofactors, pharmaceutical, immunogens, polysaccharides, toxins, cells, cell walls, cell capsules, viral capsules, viral coats, tissue, flagellae, fimbriae or pili, microorganisms, nucleic acids (e.g., DNA or DNA fragments, RNA, microRNA, long non-coding RNA, circular RNA, messenger RNA, ribosomal RNA, transfer RNA, trans-renal DNA or RNA), nucleic acids complexed to protein or polysaccharide, or lipids complexed to protein or polysaccharide.

In some embodiments, the analyte can be part of a multimolecular complex, such as, for example, a multiprotein complex, a nucleic acid/protein complex, a molecular machine, an organelle, a ribosome, spliceosome, vault, proteasome, DNA polymerase III holoenzyme, RNA polymerase II holoenzyme, symmetric viral capsids, GroEL/GroES; membrane protein complexes: photosystem I, ATP synthase, nucleosome, centriole and microtubule-organizing center (MTOC), cytoskeleton, flagellum, nucleolus, stress granule, germ cell granule, or neuronal transport granule, or any macromolecular complex or structure or other entity that can be captured and is amenable to analysis by the technology described herein.

In some embodiments, two, three, four, five, or more different analytes may be detected. In some embodiments, wherein two or more different analytes are to be detected, the two or more different analytes are the same type of analytes (e.g., two or more proteins present in a complex). In some embodiments, wherein two or more different analytes are to be detected, the two or more different analytes are different types of analytes.

A “binding agent” suitable for use according to the methods described herein is any molecule that specifically binds to an analyte (e.g., antigen) of interest. In some embodiments, the binding agent is an antibody or a portion thereof. Other embodiments provide receptors for particular analytes, such as insulin or a cytokine, as the binding agent. In some embodiments, the binding agent is biotinylated so as to be localized (using avidin for example) to an imaging zone for the capture of the analyte. Alternatively, the binding agent can be printed to an imaging zone or otherwise localized to an imaging zone at a specific location (an addressable location) to permit multiplex analysis of the sample. In various embodiments, the imaging zone can be functionalized with one or more binding agent that binds an analyte that is selected from antibodies, aptamers, enzymes, hormones, interleukins, chemokines, growth regulators, clotting factors, phosphoproteins, immunogens, polysaccharides, toxins, nucleic acids, cell walls, cell capsules, viral capsules, viral coats, flagellae, fimbriae, pili, microorganisms, lipids, or combinations thereof. The affinity of binding agents is typically described in terms of their dissociation constant or K_{D} for the interaction where most relevant values are often μM, nM, pM or lower. For antibody-antigen interactions typical Kis are often in the 0.1 to 1 to 10 nM range. In other embodiments the binding agent is a single stranded nucleic acid or contains a portion or region that is single stranded and the analyte is another nucleic acid that is complementary or contains a region of complementarity to the single stranded binding agent or single-stranded portion thereof.

A detection agent, detection probe, or query probe suitable for use with the disclosed microplate is any molecule that specifically binds to an analyte (e.g., antigen) of interest with low affinity (as described above). In some embodiments, the binding agent is a low-affinity antibody or a portion thereof that specifically binds to the analyte, or a nanobody. In some embodiments, the detection agent is an aptamer, a nucleic acid sequence, a DNA-binding protein, RNA-binding protein, or a DNA-binding ribonucleoprotein complex. Other embodiments provide low affinity receptors for particular analytes, such as insulin, as the binding agent. The detection agent is labeled with a fluorophore that permits the detection of the analyte using a SiMREPS assay. For multiplex assays, the detection agent specific for each analyte can be labeled with a different fluorophore to permit differentiation of the analytes found in the sample. In other multiplex formats, the same fluorophore can be used when the analytes are differentiated on the surface by their location or by co-localization to a second distinct signal associated with different binding agents. Detection agents typically form stable, long-lived interactions with their binding partner and therefore most typically having binding affinities or K_{D} values in the μM, nM, pM or lower range. K_{D} values are defined in terms of the rate of molecule binding and expressed as the ratio of the off rate to on rate. A stable detection complex would have a slow off rate for example. In some embodiments, e.g., SiMREPS assays, the off rate is fast in order to observe repeated interactions of detection agent to the target analyte. The disclosed microplate can be used, for example, in methods for the detection of a nucleic acid, e.g., a short nucleic acid such as a miRNA, in a sample. In such methods, nucleic acids are immobilized in the imaging zone as discussed herein. Target nucleic acids in the sample are stably immobilized by binding agents localized on the imaging zones of the microplate. A composition comprising a detection agent (e.g., a fluorescently labeled nucleic acid probe) of 6 to 12 nucleotides (e.g., 6, 7, 8, 9, 10, 11, or 12 nucleotides) is then concomitantly or subsequently provided to the imaging zone via a microchannel and the binding of the detection agent to each immobilized target nucleic acid is observed. Where multiple detection agents are provided to an imaging zone, each detection agent can be labeled with a distinct fluorescent moiety. Such methods are discussed, for example, in U.S. Pat. No. 10,093,967, the disclosure of which is hereby incorporated by reference in its entirety. In other embodiments, the detection moiety is comprised of both a region that stably interacts with the analyte immobilized by binding agents, as well as a separate region that repetitively binds and dissociates from the analyte as described for SiMREPS assays. In this assay format, detection may be performed using FRET where a detectable signal (gained or lost) is formed upon each temporal binding and rapid dissociation event.

As used herein, a “capture probe” is any entity that recognizes, binds to, or hybridizes to an analyte and links the analyte to a solid support, including, for example a microfluidic microplate. In exemplary embodiments, the capture probe is a protein or nucleic acid that recognizes an analyte. In exemplary embodiments, the analyte can be a protein, DNA, RNA, nucleic acid comprising DNA and RNA, nucleic acid comprising modified bases and/or modified linkages between bases. In certain embodiments, a capture probe is labeled, including, for example, a detectable label. In certain embodiments, the capture probe comprises at least one type of molecule.

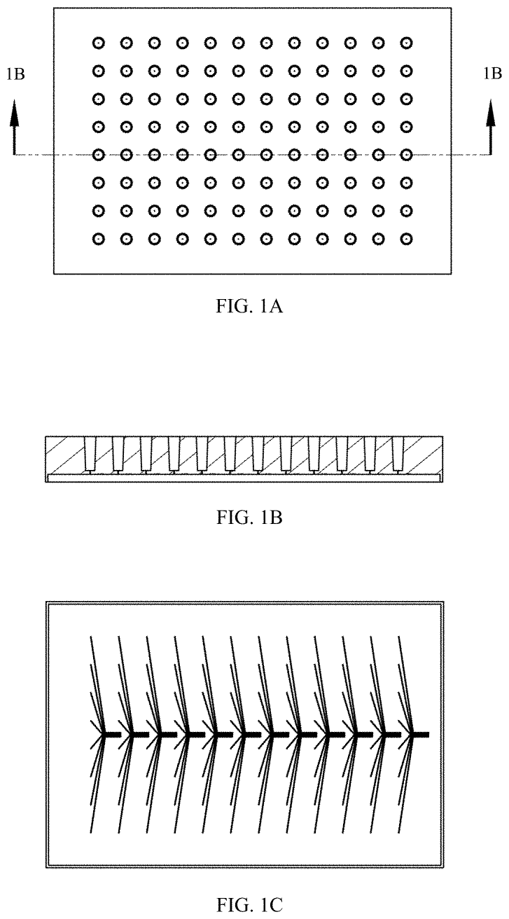

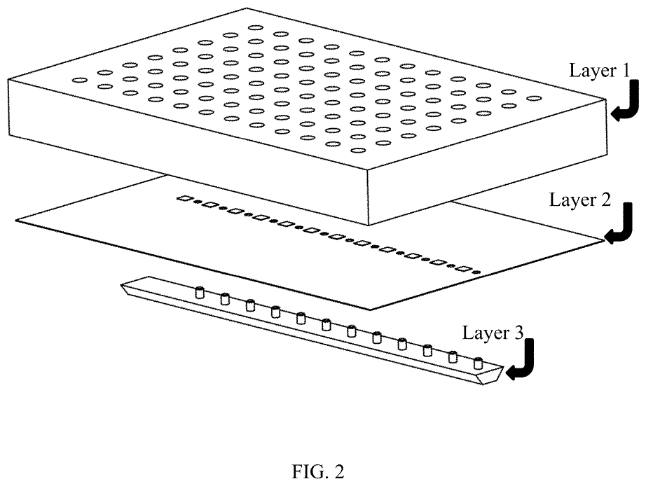

The figures provided herein provide a basic understanding of the disclosed microplates (see, for example, FIGS. 1-5). It is understood that the figures are illustrative and that other embodiments of the disclosed microplates are embraced by this disclosure. As illustrated in FIG. 2, each well is fluidly connected to a microchannel on the opposing face of the substrate. In the embodiment shown in FIG. 2, the wells and the microchannels are fabricated on the same substrate layer and the detection region (imaging zone) is located on the surface of layer 2. In other embodiments, the imaging zone and microchannels are found on Layer 2 and gaskets (or other means of bonding such as adhesives, cements and/or solvents) are provided on the lower surface of Layer 1 or on the upper surface of Layer 2 to seal the microchannels from one another and prevent contamination of samples flowing from different wells. Where the microplate is composed of two layers, Layer 1 and Layer 2 can be aligned using posts and/or holes accepting the posts in each respective layer.

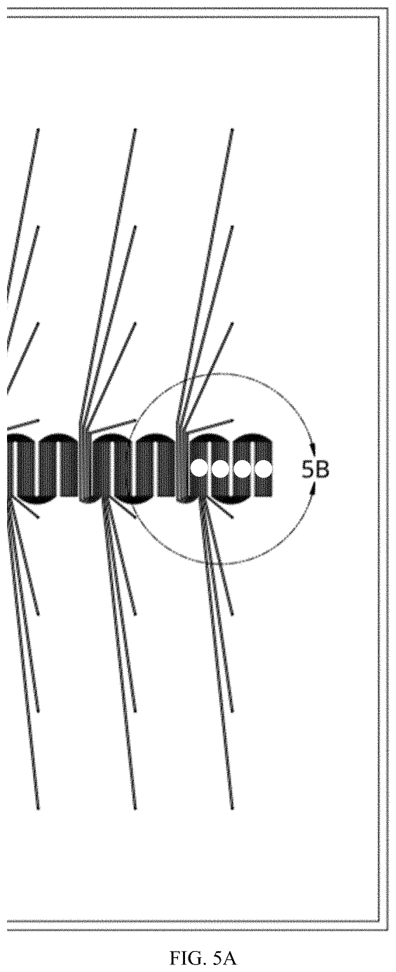

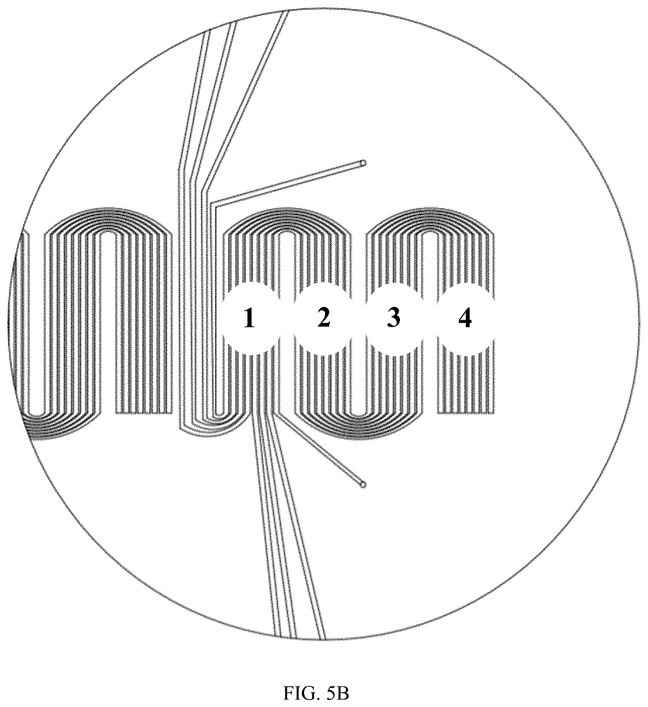

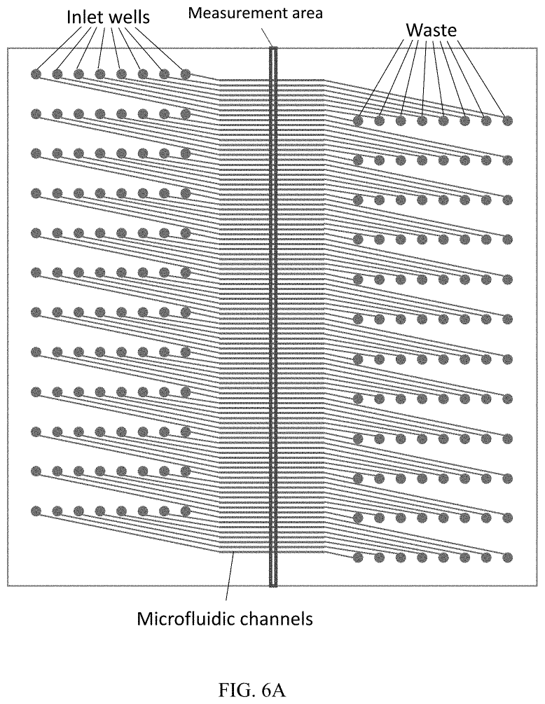

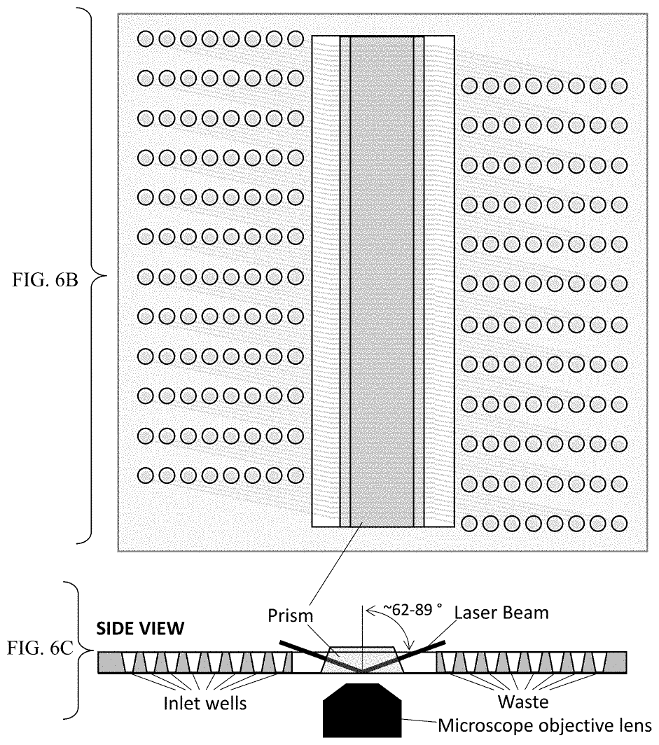

Samples are drawn from each individual well using vacuum or pressure and ports for applying the vacuum are provided in Layer 3 (see, for example, FIG. 5). In other embodiments, the ports for applying the vacuum can be provided in Layer 2 or Layer 1 (see, for example FIG. 6A). Where the device comprises two layers, the ports for applying the vacuum can be located in the prism element of Layer 2 or any other location such that the vacuum can be used to move fluids from the wells to the imaging zone and, eventually, into waste reservoirs.

In some embodiments, the microplate can further comprise an alignment feature in addition to the guide holes used to align the layers of the microplate. Such alignment features include, but are not limited to, a corner chamfer, a pin, a slot, a cut corner, an indentation, a graphic, or other unique feature that is capable of interfacing with a corresponding feature formed in a device, such as a detection device (system). Additional embodiments provide for features that permit the use of robotic systems to manipulate the plate, such as automated picking and placing of the plate in a detection device or system. In additional embodiments, the microplate can further comprise markings, such as graphics, printing, lithograph, pictorial representations, symbols, bar codes, handwriting, drawings, etchings, indentations, embossments or raised marks, machine readable codes (i.e., bar codes, etc.), text, logos, colors, and the like. These markings can, in some embodiments, be permanent. The markings can be printed upon a microplate using a printing system, non-limiting examples of which include inkjet printing, pad printing, laser printing, and hot stamping. The markings can be used to indicate wells by row and column or other identifying information for a particular microplate (such as harcodes for identification of sample sources, registration of a microplate in an automated system, etc.). The markings can also be used for microplate orientation and/or insertion of the microplate into a detection device (for example, as a graphic as discussed above). Markings can be provided on any layer of the disclosed microplate provided that the markings are visible to a detection system.

### Layer 1

In various embodiments, the layer containing the well (Layer 1), through hole and, optionally, the microchannels is transparent. In other embodiments, Layer 1 can be opaque. Regardless of the transparency of the layers, the optical signal from the imaging zone is observed by the detector below the prism.

Layer 1 of the microfluidic microplate can be manufactured by a conventional injection molding process and all commonly used thermoplastics suitable for injection molding can be used as a substrate material for the microplate. In some preferred embodiments, the microfluidic microplate is made from a polystyrene material which is well known in the art as a suitable material for microplates. A wide variety of methods and materials exists and will be known and appreciated by one of skill in the art for construction of microfluidic channels and networks thereof, such as those described, for example, in U.S. Pat. No. 8,047,829 and U.S. Patent Application Publication No. 20080014589, each of which is incorporated herein by reference in its entirety. For example, the microfluidic channel may be constructed using tubing, but may further involve sealing the surface of one layer comprising open channels to a second layer. Materials into which microfluidic channels may be formed include silicon, glass, silicones such as polydimethylsiloxane (PDMS), and plastics such as poly(methyl-methacrylate) (known as PMMA or “acrylic”), cyclic olefin polymer (COP), and cyclic olefin copolymer (COC). The same materials can also be used for the second sealing layer.

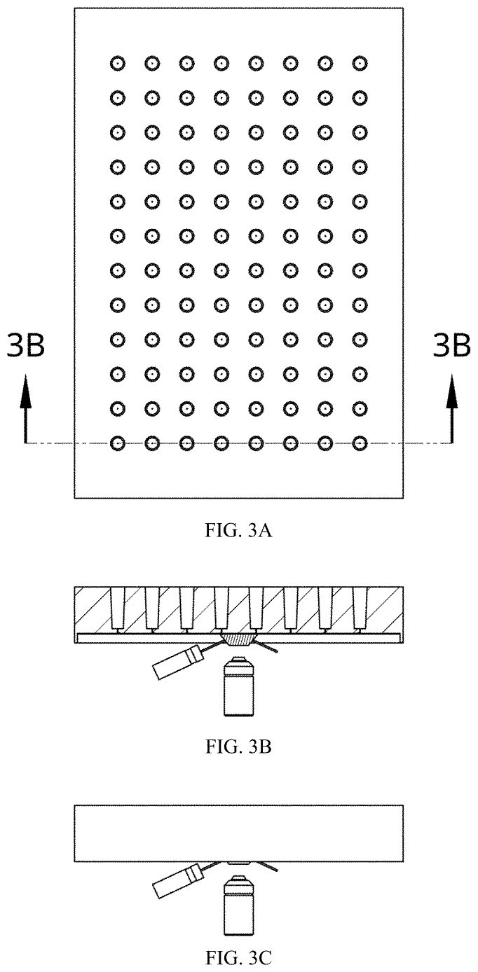

The well structure shown in FIG. 3 has a tapered configuration with a through hole and microchannel. While the bottom of the well is shown as flat, it, too, can have a taper or conical shape to allow for complete removal of well contents as opposed to having a small through hole at the base of a cylindrical well structure. As is readily apparent, the wells can have a variety of configurations. For instance, the through hole can be offset to one side of the well or the microchannel pattern can have various configurations. Additionally, the relative depth and/or position of the well structure and microchannel with respect to total plate thickness can vary. As discussed herein, Layer 1 can, optionally, contain one or more exit ports in fluid connection to imaging zones to facilitate removal of fluids from the imaging zones. The valve can be configured as a one-way valve to permit removal of fluids from the imaging zone.

### Layer 2

Layer 2 is a material, such as glass or a plastic, having a refractive index of at least 1.5 or about 1.5. Non-limiting examples of such materials include glass used in coverslips, quartz glass, or other materials having a refractive index of at least 1.5 or about 1.5. In other embodiments, Layer 2 is a plastic having a refractive index of at least 1.5 (or about 1.5) and, optionally, having low autofluorescence at the wavelength of light used to measure signal (for example, the red and/or far red region of the light spectrum). In various embodiments, the refractive index ranges between about 1.5 and about 1.9 or about 1.5 to about 1.75. In various embodiments, Layer 2 can also, optionally, contain one or more exit port that is fluidly connected to the imaging zones so as to facilitate removal of fluids from the imaging zones. The valve can be configured as a one-way valve to permit removal of fluids from the imaging zone.

As discussed above, Layer 2 can be constructed such that the entire layer comprises a high refractive index material suitable for use as a waveguide in waveguide TIRF and the prism aspect of Layer 3 can be omitted. In some embodiments, Layer 2 can be a composite material that integrates a waveguide comprising high refractive index materials upon which the imaging zones are deposited which is then integrated into other Layer 2 materials, such as plastics or other materials that can surround the waveguide material. Non-limiting examples of materials suitable for use in Layer 2 are: glass, borosilicate glass, fused silica, silicon nitride, tantalum pentoxide, and various plastics (e.g., cyclic olefin polymer, cyclic olefin copolymer), having a refractive index of at least 1.5 and which permit total internal reflection at the imaging zone. In various embodiments, the refractive index of the waveguide material ranges between about 1.5 and about 1.9 or about 1.5 to about 1.75.

Imaging zones on the upper surface of Layer 2 can be functionalized so as to localize a binding agent to the area defining the imaging zone. For example, the surface of Layer 2 can be functionalized with a functionalization agent on the upper surface of the layer containing the imaging zone. In some embodiments, the functionalization agent binds to a functional group present on the upper surface of the imaging zone. In other embodiments, an active functionalization agent binds to a reactive group on a surface and comprises a functional group that is reactive with a specific binding agent (e.g., an antibody or nucleic acid), thereby supporting a coupling reaction to the surface. In some cases, a functionalization agent comprises a carboxyl, amine, thiol, or hydroxyl functional group. In some instances, functionalization of certain surfaces, such as PMMA, allows for a one step process, which eliminates the need for deposition of a layer of active agent. Individual imaging zones can have a range of sizes, provided that the imaging zone can be imaged with a detector and having an objective lens providing having a field of view (FOV) with a diameter or width that is about 0.1 mm, about 0.2 mm, about 0.3 mm, about 0.4 mm, about 0.5 mm, about 0.1 mm to about 1.0 mm, about 0.1 mm to about 5.0 mm, about 0.1 mm to about 2.5 mm, about 0.1 mm to about 2 mm, about 0.25 mm to about 0.75 mm, about 0.5 mm to about 5.0 mm, about 1.0 mm to about 5.0 mm, about 1.0 mm to about 3.0 mm, or about 1.5 mm to about 2 mm. For example, an individual imaging zone can have FOV of between about 50,000 μm² and about 1,000,000 μm², about 200,000 μm² and about 950,000 μm², about 220,000 μm², about 225,000 μm², or about 950,000 μm².

In some embodiments, a binding agent is immobilized by linking it directly to the imaging zone, e.g., by using any of a variety of covalent linkages or by linking it indirectly via one or more linkers joined to the support. In some embodiments, the binding agent is a nucleic acid and the linker is a nucleic acid comprising one or more nucleotides that is/are not intended to hybridize (e.g., that do not hybridize) to a target nucleic acid but which act as a spacer between the binding agent and the imaging zone. In some embodiments, the binding agent comprises a biotin group (e.g., the binding agent is biotinylated) and the imaging zone comprises a streptavidin group (e.g., attached to the solid support by a linker moiety, e.g., a polyethylene glycol (PEG) linker).

Various other chemical methods can be employed for the immobilization of binding agents to a solid support, such as the use of a maleimide group and a thiol (—SH) group. In this method, a thiol (—SH) group is provided at the end of a binding agent and a maleimide group is provided in the imaging zone. The thiol group reacts with the maleimide group to form a covalent bond, thus immobilizing the binding agent. Such immobilization techniques are described in U.S. Pat. No. 10,093,967 (the disclosure of which is hereby incorporated by reference in its entirety).

In other embodiments, functionalization of a surface comprises deposition of a functionalization agent to the surface, where the agent self-assembles as a layer on the surface. Non-limiting examples of self-assembly agents include n-octadecyltrichlorosilane, 11-bromo undecyltrichlorosilane, 1H, 1H,2H,2H-perfluoro-decyltrichlorosilane, N-[3-(trimethoxysilyl)propyl]-ethylenediamine, (3-aminopropyl)trimethoxy-silane, (3-aminopropyl)triethoxysilane, (3-mercaptpropyl)trimethoxysilane, PEG silanes (having a trichlorosiloxane, trimethoxysiloxane, or triethoxysiloxane functional group), N-(6-aminohexyl)-3-aminopropyltrimethoxysilane, phenyltrichlorosilane, benzyltrichlorosilane, n-octadecyltrim ethoxy silane, heptadecafluoro-1,1,2,2-tetrahydro-decyl-1-trimethoxy-silane, 3,3,3-trifluoropropyltrimethoxy silane, (4-chloromethyl)phenyltrimethoxysilane, 18-nonadecenyltrichlorosilane, and 2,2,2-trifluoroethyl undec-10-enoate.

In yet other embodiments, the functionalization agent comprises a silane group that binds to a surface of a structure, while the rest of the molecule provides a distance from the surface and a free hydroxyl group (or other reactive group such as a thiol, carboxyl, or amine group) at the end to which a biomolecule attaches. Non-limiting examples of silanes include N-(3-triethoxysilylpropyl)-4-hydroxybutyramide (HAPS), 11-acetoxyundecyltriethoxysilane, n-decyltriethoxysilane, (3-aminopropyl)trimethoxy silane, (3-aminopropyl)tri ethoxysilane, 3-glycidoxypropyltrimethoxysilane (GOPS), 3-iodo-propyltrimethoxysilane. In some instances, a silane is an amino silane. In some instances, a silane is an organofunctional alkoxysilane molecule. Non-limiting examples of organofunctional alkoxysilane molecules include butyl-aldehyde-trimethoxysilane; dimeric secondary aminoalkyl siloxanes; aminosilanes such as (3-aminopropyl)-triethoxy silane, (3-aminopropyl)-diethoxy-methylsilane, (3-aminopropyl)-dimethyl-ethoxysilane, and (3-aminopropyl)-trimethoxysilane; glycidoxysilanes such as (3-glycidoxypropyl)-dimethyl-ethoxysilane and glycidoxy-trimethoxysilane; and mercaptosilanes such as (3-mercaptopropyl)-trimethoxysilane, 3-4 epoxycyclohexyl-ethyltrimethoxysilane and (3-mercaptopropyl)-methyl-dimethoxysilane. Organofunctional silanes include siloxanes such as hydroxyalkyl siloxanes, including allyl trichlorosilane as a precursor for 3-hydroxypropyl and 7-oct-1-enyltrichlorosilane as a precursor for 8-hydroxyoctyl; diol (dihydroxyalkyl) siloxanes including glycidyl trimethoxysilane-derived (2,3-dihydroxypropyloxy)propyl (GOPS); aminoalkyl siloxanes, including 3-aminopropyl trimethoxysilane; and dimeric secondary aminoalkyl siloxanes, including bis (3-trimethoxysilylpropyl) amine as a precursor for bis(silyloxylpropyl)amine.

In yet other embodiments, binding agents, such as antibodies or nucleic acid sequences, can be printed or otherwise dispensed/disposed onto the upper surface of Layer 2 in the imaging zone. In specific embodiments, the binding agent can be printed to an imaging zone or otherwise localized to an imaging zone at a specific location (an addressable location) to permit multiplex analysis of the sample.

### Layer 3

Layer 3 of the microplate is a prism suitable for use in prism TIRF. The prism can be constructed of a material that has a refractive index that is similar or identical to the refractive index of Layer 2. In various embodiments, the refractive index of Layer 3 is at least 1.5 or about 1.5. In various additional embodiments, the refractive index ranges between about 1.5 and about 1.9 or about 1.5 to about 1.75. The prism of Layer 3 can be attached to the lower portion of Layer 2 by an optical cement (or another material or solution having a matching refractive index, such as an oil or gel) or, in the two layer embodiment, formed as a single layer of the same or differing materials, provided that if differing materials are used, the materials are index matched in the constructions of Layer 2 (e.g., have the same or similar refractive index). Non-limiting examples of materials for use as Layer 3 include quartz, plastics, glass or flint glass. Other non-limiting examples of materials that can be used in Layer 3 are: glass, borosilicate glass, fused silica, silicon nitride, tantalum pentoxide, and various plastics (e.g., COP, COC), as long as the refractive index is high enough to permit total internal reflection at the imaging zone. In various embodiments, the materials of Layers 2 and 3, and optionally Layer 1, exhibit little or no autofluorescence.

The presently described device can be used to conduct single analyte assays in which a binding agent specific for a single analyte is localized to an imaging zone. Alternatively, the presently described device can also be used to detect one or more analyte in a single assay, and are thus capable of use in multiplex assays. For example, binding agents that are specific for multiple analytes can be immobilized on the surface of an imaging zone and used to detect multiple analytes in a sample. The analytes can be differentiated using different fluorophores or by using an addressable array in which the different binding agents are immobilized on the imaging zone. As used herein, the term “addressable array” includes a spatially or physically ordered array, wherein the binding agent is localized on the imaging zone. An addressable array includes a collection of binding agents, such as antibodies or nucleic acids, containing two or more members and is one in which the members of the array are identifiable, typically by position on the imaging zone. In general, the members of the array are immobilized on discrete identifiable loci on the imaging zone. Various methods of preparing such arrays are known in the art.

The disclosed microplate provides for a variety of advantages over the current state of the art. Non-limiting examples of these advantages include:

1. Potential for faster plate throughput or read times since samples from multiple wells are bundled into a single imaging zone. For an embodiment where channels from 8 wells are bundled and imaged simultaneously (for example, refer to FIG. 1C) throughput can be increased by 8×.

2. Multiple samples can be loaded and imaged at once giving improved assay reproducibility and consistency.

3. Simple vacuum initiated method to deliver equivalent assay times for each sample.

4. Low sample volume requirements since microchannels are used.

5. Fast binding times (˜15 min) with microchannels.

6. Ease of use. Load samples and go as design is amenable to automation.

7. The assays can be performed at relatively low cost using injection molded parts containing sample wells and channels, a standard coverglass and single prism.

8. Simplified surface functionalization using well established methods on glass.

9. Simplified surface functionalization on manufacturing scale. Only small zones (imaging zones) on coverglass or prism require functionalization.

10. Reduced reagent consumption/cost for surface functionalization due to small imaging zones.

11. The instrument design for reading the plates is simplified. A simplified design results in lower cost and the instrument can have fixed laser and objective lens positions and a single prism. A single axis movement of plate (along prism length on the microplate) also simplifies imaging of different samples. The instrument would also only require a low cost pump, pressure actuator and hardware to engage a vacuum needle for movement of fluids.

### Systems and Methods of Using the Microfluidic Microplate

The disclosed microfluidic microplates can be used for “single-molecule recognition through equilibrium Poisson sampling” or “SiMREPS,” which is an amplification-free, single-molecule detection approach for identifying and counting analytes in samples by “kinetic fingerprinting”. As used herein, the term “kinetic fingerprinting” is used interchangeably with the term “SiMREPS”. The technology is described in U.S. Pat. No. 10,093,967; U.S. patent application Ser. Nos. 16/154,045; 16/076,853; 15/914,729; 16/219,070; 17/193,060 and Int'l Pat. App. No. PCT/US19/43022, each of which is incorporated herein by reference in its entirety. SiMREPS can comprise directly observing the repeated binding of probes, including, for example, fluorescent probes, to surface-captured analytes, which can produce a specific kinetic fingerprint, such as, for example, a sequence specific kinetic fingerprint. The sequence-specific kinetic fingerprint can be highly sensitive to small differences in the analyte such as, for example, single-nucleotide substitutions, allowing the discrimination between closely related sequences with high specificity.

In certain embodiments, the signal originating from the transient binding of the query probe to the analyte is distinguishable from the signal produced by the unbound query probe. In certain embodiments, the transient binding of the query probe to the analyte can be observed by a technology such as, for example, total internal reflection fluorescence (TIRF) or near-TIRF microscopy, zero-mode waveguides (ZMWs), light sheet microscopy, stimulated emission depletion (STED) microscopy, or confocal microscopy. In certain embodiments, the query probes can have a fluorescence emission that is quenched when not bound to the analyte and/or a fluorescence emission that is dequenched when bound to the analyte.

In particular embodiments, a protein analyte can be detected using a capture probe and/or a query probe comprising an antibody or antigen-binding antibody fragment, including, for example, IgG, (Fab)₂, monovalent Fab, nanobody, or single-chain variable fragment antibody); an aptamer, such as, for example, a nucleic acid or peptide aptamer; or a naturally occurring binding partner of the protein analyte, a peptide sequence of a protein analyte, or a post-translational modification of the protein analyte.

In certain embodiments, transitions, such as, for example, the binding and the dissociation of one or more query probes to or from a target analyte, can be counted for each well or channel in the disclosed microfluidic microplate where an analyte is immobilized. In certain embodiments, a threshold number of transitions can be used to discriminate the presence of an analyte in a well in the disclosed microfluidic microplate from the background signal. In certain embodiments, a distribution of the number of transitions for each immobilized target can be determined. In certain embodiments, characteristic parameters of the distribution are determined, such as, for example, the mean, median, peak, and shape. In certain embodiments, data and/or parameters can be analyzed by algorithms that recognize patterns and regularities in data, such as, for example, using artificial intelligence, pattern recognition, machine learning, statistical inference, or neural nets. In certain embodiments, the analysis comprises the use of a frequentist analysis or Bayesian analysis. In some embodiments, pattern recognition systems can be trained using known “training” data and in some embodiments algorithms can be used to identify previously unknown patterns. Pattern recognition (e.g., using training sets, supervised learning, unsupervised learning, and analysis of unknown samples) associates identified patterns with analytes such that particular patterns provide a “fingerprint” of particular analytes that find use in detection, quantification, and identification of analytes.

In certain embodiments, the distribution produced from an analyte is significantly different than a distribution produced from a non-analyte or the distribution produced in the absence of an analyte. In certain embodiments, a mean number of transitions can be determined for the plurality of immobilized analytes. In some embodiments, the mean number of transitions observed for a sample comprising an analyte is approximately linearly related as a function of time and has a positive slope.

In certain embodiments, the disclosed microfluidic microplate can be used for single-molecule recognition by recording the characteristic kinetics of a query probe binding to a target analyte. In certain embodiments, this data can be processed as a Poisson process. A Poisson process can be a continuous-time stochastic process that counts the number of events and the time that events, such as, for example, transient binding of a detectably labeled query probe to an immobilized target analyte, occur in a given time interval. The time interval between each pair of consecutive events can have an exponential distribution and each interval is assumed to be independent of other intervals. The Poisson distribution is a discrete probability distribution that expresses the probability of a given number of the events occurring in the given time interval if these events occur with a known average rate and independently of the time since the last event. The Poisson distribution can also be used for the number of events in other specified intervals such as distance, area, or volume.

A Poisson distribution is a special case of the general binomial distribution where the number of trials n is large, the probability of success p is small, and the product np=λ, is moderate. In a Poisson process, the probability that a number of events N is j at any arbitrary time t follows the Poisson probability distribution Pᵢ(t):

$${P}_{j} ( t ) = \frac{{{e}^{- λ t} ( λ t )}^{j}}{j !} , j = 0 , 1 , 2 , …$$

That is, the number, N, of events that occur up to time, t, has a Poisson distribution with parameter Xt. Statistical and mathematical methods relevant to Poisson processes and Poisson distributions are known in the art. See, e.g., “Stochastic Processes (i): Poisson Processes and Markov Chains” in Statistics for Biology and Health—Statistical Methods in Bioinformatics (Ewans and Grant, eds.), Springer (New York, 2001), page 129 et seq., incorporated herein by reference in its entirety. Software packages such as Matlab and R may be used to perform mathematical and statistical methods associated with Poisson processes, probabilities, and distributions.

In certain embodiments, an analyte can be detected by analyzing the kinetics of the interaction of a query probe with the analyte to be detected. For the interaction of a query probe

Q, such as, for example, at an equilibrium concentration [Q], with a target analyte T, such as, for example, at an equilibrium concentration [T], the kinetic rate constant kₒₙ can describe the time-dependent formation of the complex QT comprising the probe Q hybridized to the analyte T. In certain embodiments, while the formation of the QT complex can be associated with a second order rate constant that is dependent on the concentration of query probe and has units of M⁻¹ min⁻¹ (or the like), the formation of the QT complex can be sufficiently described by a koothat is a pseudo-first order rate constant associated with the formation of the QT complex. In certain embodiments, km can be an apparent (“pseudo”) first-order rate constant.

In certain embodiments, the kinetic rate constant koff can describe the time-dependent dissociation of the complex QT into the probe Q and the analyte T. Kinetic rates are typically provided herein in units of min⁻¹ or s⁻¹. The “dwell time” of the query probe Q in the bound state (τₒₙ) can be the amount of time that the probe Q is hybridized to the analyte T during each instance of query probe Q binding to the analyte T to form the QT complex. The “dwell time” of the query probe Q in the unbound state (τ_{off}) can be the amount of time that the probe Q is not hybridized to the analyte T between each instance of query probe Q binding to the analyte to form the QT complex. Dwell times may be provided as averages or weighted averages integrating over numerous binding and non-binding events.

In certain embodiments, the repeated, stochastic binding of probes to target analytes can be modeled as a Poisson process occurring with constant probability per unit time and in which the standard deviation in the number of binding and dissociation events per unit time (N_{b+d}) increases as (N_{b+d})^{1/2}. Thus, the statistical noise becomes a smaller fraction of N_{b+d} as the observation time is increased. In certain embodiments, observation time can be increased as needed to achieve discrimination between target and off-target binding. And, as the acquisition time is increased, the signal and background peaks in the N_{b+d} histogram can become increasingly separated and the width of the signal distribution increases as the square root of N_{b+d}, consistent with kinetic Monte Carlo simulations.

In certain embodiments, assay conditions can be modified in various way to produce query probe binding to analyte events that are distinct from background binding, such as, for example, using a query probe that is designed to interact weakly with the target analyte, such as, for example, in the nanomolar affinity range; controlling the temperature such that the query probe interacts weakly with the target analyte; controlling the solution conditions, such as, for example, ionic strength, ionic composition, addition of chaotropic agents, and addition of competing probes.

In certain embodiments, the query probe can comprise a fluorescent label. Detection of fluorescence emission at the emission wavelength of the fluorescent label can indicate that the query probe is bound to an immobilized analyte. Binding of the query probe to the analyte is a “binding event”. In certain embodiments, a binding event has a fluorescence emission with a measured intensity greater than a defined threshold. In certain embodiments, a binding event can be indicated when a fluorescence intensity that is greater than the background fluorescence intensity is observed, such as, for example, at least 1, 2, 3, 4, 5, or more standard deviations greater than the background fluorescence intensity. In certain embodiments, the length of time between when the binding event started and when the binding event ended is the dwell time of the binding event. A “transition” refers to the binding and dissociation of a query probe to and from the analyte (e.g., an on/off event). Fluorescence detected in a negative control sample is “background fluorescence.”

As used herein, the phrases “detect an analyte” or “detect a substance” refer to the direct detection of the analyte itself or indirect detection of the analyte by detecting its by-product(s).

In certain embodiments, a labeled nucleic acid can be detected. In certain embodiments, a detectably fluorescently labeled query probe and a detector of fluorescent emission, such as a fluorescent microscopy technique, can be used. In certain embodiments, unlabeled nucleic acids can be captured on the disclosed microfluidic microplate that specifically binds one segment of the target, followed by observation of the repeated, transient binding of a short detectably labeled nucleic acid query probe to a second segment of the target.

In certain embodiments, the technology relates to use of SiMREPS for detecting the presence, absence, and/or quantity of an analyte using query probes labeled with two or more different labels, such as, for example, fluorescent labels. In certain embodiments, the technology comprises use of two or more query probes that are specific for the same analyte and that comprise two or more different labels.

In some embodiments, the two or more query probes comprise a first query probe comprising a first label and a second query probe comprising a second label and, optionally, a third, fourth, fifth, sixth, seventh, eighth, ninth, tenth, or more query probe comprising, respectively, a third, fourth, fifth, sixth, seventh, eighth, ninth, tenth, or more label. In certain embodiments, the first query probe can have a different label than the second query probe. In some embodiments, the first query probe can be the same query probe as the second query probe, such as, for example, a first portion of the query probe molecules comprises a first label and a second portion of the query probe molecules comprises a second label. The query probes comprising two or more different labels can be provided in a composition for SiMREPS and deposited on a microfluidic microplate surface as described herein. In certain embodiments, the surface-immobilized analyte can be detected when the multiple fluorophores repeatedly appear in the same location or well, indicating the repeated binding of the multiple probes comprising each of the two or more labels.

In certain embodiments, the two or more query probes comprise a first query probe comprising a first label and a second query probe comprising a second label and the first label and the second label are a Forster resonance energy transfer (FRET) pair. In certain embodiments, query probes comprising FRET pair labels that bind to the same analyte simultaneously in a manner that positions the two FRET pair labels close enough that FRET occurs between the two labels and the emission by the FRET acceptor can be detected. In certain embodiments, the distance between the two FRET labels can be less than about the Forster radius of the two labels, including, for example about 2 to about 10 nanometers (nm) or 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, or 9.9 nm. In certain embodiments, using two or more labels, detecting an analyte is associated with detecting a signal indicating a particular kinetic signature of switching between fluorescent and non-fluorescent states or between FRET and non-FRET states.

In certain embodiments, use of two or more probes and/or two or more labels provides a more specific signal than use of a single query probe by reducing false positives. In certain embodiments, the use of two or more query probes increases sensitivity and/or specificity as the likelihood of two differently labeled probes binding close to one another in the disclosed microfluidic microplate and producing a spurious repeated blinking signal is much lower than the likelihood of two differently labeled probes binding close together by binding the same analyte molecule.

In certain embodiments, an analyte can be captured and, optionally, immobilized. In certain embodiments, the analyte can be stably attached to a microfluidic microplate, as disclosed herein.

In some embodiments, stable attachment of an analyte to the disclosed microfluidic microplate can be provided by a high-affinity or irreversible interaction. In certain embodiments a high-affinity or irreversible interaction can range from about 1 minute to about 10 minutes, about 1 minute to about 8 minutes, about 1 minute to about 6 minutes, or about 1 minute to about 5 minutes.

In certain embodiments, an analyte can be immobilized on the disclosed microfluidic microplate by a surface-bound capture probe with a dissociation constant (K_{D}) for the analyte of less than about 0.5 nanomolar (nM), or about 0.5 nM to about 1.5 nM, about 0.6 nM to about 1.4 nM, about 0.7 nM to about 1.3 nM, about 0.8 nM to about 1.2 nM, about 0.9 nM to about 1.1 nM, or about 1 nM. In certain embodiments, an analyte can be immobilized by a surface-bound capture probe with a k_{off} for the analyte of less than about 0.01 min⁻, or about 0.01 min⁻¹ to about 1 min⁻¹, about 0.1 min⁻¹ to about 1 min⁻¹, about 0.01 min⁻¹ to about 0.1 min⁻¹,about 0.5 min⁻¹ to about 1.5 min⁻¹, about 0.6 minⁱ to about 1.4 min⁻¹, about 0.7 min⁻¹ to about 1.3 min⁻¹, about 0.8 min⁻¹ to about 1.2 min⁻¹, about 0.9 min⁻¹ to about 1.1 min⁻¹, or about 1 min⁻¹. In certain embodiments, the capture probe can include, for example, an antibody, antibody fragment, nanobody, or other protein; a high-affinity DNA-binding protein or ribonucleoprotein complex, such as, for example, Cas9, dCas9, Cpf1, transcription factors, or transcription activator-like effector nucleases (TALENs); an oligonucleotide; a small organic molecule; or a metal ion complex. In certain embodiments, the capture probe can be a rabbit monoclonal antibody.

In certain embodiments, an analyte can be immobilized on the disclosed microfluidic microplate by direct noncovalent attachment to the disclosed microfluidic microplate. In certain embodiments, an analyte can be immobilized by chemical linking, including, for example, a covalent bond of the analyte to the disclosed microfluidic microplate. In some embodiments, the analyte can be chemically linked to the solid support by, for example, a carbodiimide, a N-hydroxysuccinimide esters (NHS) ester, a maleimide, a haloacetyl group, a hydrazide, or an alkoxyamine. In certain embodiments, an analyte can be immobilized by radiation-induced cross-linking of the target analyte to the surface and/or to a capture probe attached to the surface. In certain embodiments in which the analyte comprises a carbohydrate or polysaccharide, the capture probe can comprise a carbohydrate-binding protein, such as, for example a lectin or a carbohydrate-binding antibody.

In certain embodiments, an analyte can be repeatedly and transiently bind to a query probe with a dissociation constant (K_{D}) for the analyte of more than about 0.5 nanomolar (nM), or about 0.5 nM to about 5 nM, about 0.6 nM to about 4.9 nM, about 0.7 nM to about 4.8 nM, about 0.8 nM to about 4.7 nM, about 0.9 nM to about 4.6 nM, about 1 nM to about 4.5 nM, about 1.5 nM to about 4.0 nM, about 2 nM to about 3.5 nM, about 2.5 nM, or about 1 nM. In certain embodiments, a query probe can have a dissociation rate constant or koff for the analyte of more than about 0.5 min⁻¹, or about 0.5 min^{-l}to about 40 min⁻¹, about 0.5 min⁻¹ to about 30 min⁻¹, about 0.5 min⁻¹ to about 20 min⁻¹, about 0.5 min⁻¹ to about 10 min⁻¹, about 0.5 min⁻¹ to about 7.5 min⁻¹, about 1 minⁱ to about 40 min⁻¹, about 5 minⁱ to about 40 min⁻¹, about 10 min⁻¹ to about 40 min⁻¹, about 0.5 minⁱ to about 5 min⁻¹, about 0.6 min⁻¹ to about 4.9 min⁻¹, about 0.7 min⁻¹ to about 4.8 min⁻¹, about 0.8 min⁻¹ to about 4.7 min⁻¹, about 0.9 minⁱ to about 4.6 min⁻¹, about 1 min⁻¹ to about 4.5 min⁻¹, about 1.5 min⁻¹ to about 4 min⁻¹, about 2 min⁻¹ to about 4 min⁻¹, about 2.5 min⁻¹ to about 3.5 min⁻¹, about 3 min⁻¹, or about 1 min⁻¹. In certain embodiments, a query probe can have a binding rate constant or km for the analyte of more than about 1×10⁵ M⁻¹ s⁻¹, or more than about 1×10⁶ M⁻¹ s⁻¹.

In certain embodiments, the query probe is an antibody or antibody fragment, including, for example, a low-affinity antibody or antibody fragment or mouse monoclonal antibody; a nanobody; a DNA-binding protein or protein domain; a methylation binding domain (MBD); a kinase, a phosphatase; an acetylase; a deacetylase; an enzyme; a polypeptide; or an oligonucleotide that can hybridize to the target analyte and, for example, form a duplex. In certain embodiments, the oligonucleotide-target analyte duplex can have a melting temperature within about 10° C. of the temperature at which the observations are made. In some embodiments, the query probe is a mononucleotide. In certain embodiments, the query probe can be a small organic molecule, which can be defined as a molecule having a molecular weight less than about 2100, 2050, 2000, 1950, 1900, 1850, 1800, 1750, 1700, 1650, 1600, 1550, 1500 daltons, or less. In certain embodiments, the query probe can be a pharmaceutical agent; a metal ion complex; methyl-binding domain, such as, for example, MBD1. In certain embodiments, the query probe can be labeled with a detectable label. In certain embodiments, the query probe can be covalently linked or indirectly and/or non-covalently linked and/or associated to a detectable label. In some embodiments, the detectable label is fluorescent. In certain embodiments in which the analyte comprises a carbohydrate or polysaccharide, the query probe can comprise a carbohydrate-binding protein, such as, for example a lectin or a carbohydrate-binding antibody.

In some embodiments, the technology relates to use of SiMREPS assay conditions in the disclosed microfluidic microplate wells. In some embodiments, the temperature is greater than about 25° C., 25.5° C., 26.0° C., 26.5° C., 27.0° C., 27.5° C., 28.0° C., 28.5° C., 29.0° C., 29.5° C., 30° C., 30.5° C., 31.0° C., 31.5° C., 32.0° C., 32.5° C., 33.0° C., 33.5° C., 34.0° C., 34.5° C., 35.0° C., 35.5° C., 36.0° C., 36.5° C., 37.0° C., 37.5° C., 38.0° C., 38.5° C., 39.0° C., 39.5° C., 40.0° C., 40.5° C., 41.0° C., 41.5° C., 42.0° C., 42.5° C., 43.0° C., 43.5° C., 44.0° C., 44.5° C., 45.0° C., 45.5° C., 46.0° C., 46.5° C., 47.0° C., 47.5° C., 48.0° C., 48.5° C., 49.0° C., 49.5° C., or 50.0° C. In some embodiments, the temperature is maintained at a temperature between about 25° C. to about 50° C. plus or minus about 1° C. to about 5° C. In certain embodiments, the salt or ion concentration can be about 100 nM to about 10000 nM, about 150 nM to about 600 nM, or about 200 nM to about 400 nM. In certain embodiments, the salt or ion can be a monovalent ion. In certain embodiments, the monovalent ion is sodium.

In certain embodiments, an analyte can be identified by repetitive query probe binding. In certain embodiments, methods comprise immobilizing an analyte to a solid support. In certain embodiments, the solid support is a surface, such as, for example a microfluidic microplate as disclosed herein. In certain embodiments, immobilizing an analyte to a solid support comprises a covalent or non-covalent interaction between the solid support and analyte. In certain embodiments, the analyte is stably immobilized to a surface and methods comprise repetitive binding of a query probe to the analyte. In certain embodiments, binding of a query probe to the analyte can be detected.

In certain embodiments of methods for quantifying one or more surface-immobilized analytes, the methods comprise one or more steps including, for example, measuring the signal of one or more transiently binding query probes to the immobilized analyte(s) with single-molecule sensitivity using the disclosed microfluidic microplate.

In certain embodiments, the interaction between the analyte and the query probe can be distinguishably influenced by a covalent modification of the analyte. In certain embodiments, the analyte can be a polypeptide comprising a post-translational modification. In certain embodiments, a post-translational modification of a polypeptide can affect the transient binding of a query probe with the analyte, such as, for example, the query probe signal can be a function of the presence or absence of the post-translational modification on the polypeptide. In certain embodiments, the analyte can be a nucleic acid comprising an epigenetic modification, such as, for example, a methylated base. In certain embodiments, the analyte can be a nucleic acid comprising a covalent modification to a nucleobase, a ribose, or a deoxyribose moiety of the analyte.

In certain embodiments, a modification of a nucleic acid affects the transient binding of a query probe with the analyte, such as, for example, the query probe signal is a function of the presence or absence of the modification on the nucleic acid. In certain embodiments, the transient interaction between the modification and the query probe is mediated by a chemical affinity tag, such as, for example, a chemical affinity tag comprising a nucleic acid.

In certain embodiments, the query probe and/or capture probe can be a nucleic acid or an aptamer. In certain embodiments, the query probe and/or capture probe can be a low-affinity antibody, antibody fragment, or nanobody. In certain embodiments, the query probe can be a DNA-binding protein, RNA-binding protein, or a DNA-binding ribonucleoprotein complex. In certain embodiments, capture is mediated by a covalent bond cross-linking the analyte to the surface. In certain embodiments, the analyte is subjected to thermal or chemical denaturation in the presence of a carrier prior to surface immobilization, including by using, for example, urea, formamide, guanidinium chloride, high ionic strength, low ionic strength, high pH, low pH, or sodium dodecyl sulfate (SDS).

In certain embodiments, the subject technology relates to systems for detecting analytes, such as, for example, a system for quantifying one or more analytes, in which the system comprises a microfluidic microplate as disclosed herein upon which a surface-bound capture probe or a surface-bound moiety that stably binds the analyte. In certain embodiments, the surface-bound capture probe or the surface-bound moiety stably binds the analyte via a binding site, an epitope, or a recognition site. In certain embodiments, systems further comprise a query probe that binds the analyte with a low affinity at a second binding site, a second epitope, or a second recognition site. Furthermore, certain system embodiments comprise a detection component that records a signal from the interaction of the query probe with the analyte. In certain embodiments, the detection component records the change in the signal as a function of time produced from the interaction of the query probe with the analyte. In certain embodiments, the detection component records the intensity of binding and dissociation events of the query probe to and from said analyte. In certain embodiments, the detection component records beginning and/or ending time of binding and dissociation events of the query probe to and from said analyte. In certain embodiments, the detection component records the length of time of binding and dissociation events of the query probe to and from said analyte.

In certain embodiments, a query probe and/or an analyte comprises a fluorescent moiety. Exemplary fluorescent labels include a quantum dot or a fluorophore. Examples of fluorescence labels for use in this method includes fluorescein, 6-FAM™ (Applied Biosystems, Carlsbad, Calif), 5-carboxyfluorescein (5-FAM), TET™ (Applied Biosystems, Carlsbad, Calif.), VIC™ (Applied Biosystems, Carlsbad, Calif), MAX, HEX™ (Applied Biosystems, Carlsbad, Calif), TYE™ (ThermoFisher Scientific, Waltham, Mass.), TYE665, TYE705, TEX, JOE, Cy™ (Amersham Biosciences, Piscataway, N.J.) dyes (Cy2, Cy3, Cy3B, Cy3.5, Cy5, Cy5.5, Cy7), Texas Red® (Molecular Probes, Inc., Eugene, Oreg.), Texas Red-X, AlexaFluor® (Molecular Probes, Inc., Eugene, Oreg.) dyes (AlexaFluor 350, AlexaFluor 405, AlexaFluor 430, AlexaFluor 488, AlexaFluor 500, AlexaFluor 532, AlexaFluor 546, AlexaFluor 568, AlexaFluor 594, AlexaFluor 610, AlexaFluor 633, AlexaFluor 647, AlexaFluor 660, AlexaFluor 680, AlexaFluor 700, AlexaFluor 750), DyLight™ (ThermoFisher Scientific, Waltham, Mass.) dyes (DyLight 350, DyLight 405, DyLight 488, DyLight 549, DyLight 594, DyLight 633, DyLight 649, DyLight 755), ATTO™ (ATTO-TEC GmbH, Siegen, Germany) dyes (ATTO 390, ATTO 425, ATTO 465, ATTO 488, ATTO 495, ATTO 520, ATTO 532, ATTO 550, ATTO 565, ATTO Rhol01, ATTO 590, ATTO 594, ATTO 610, ATTO 620, ATTO 633, ATTO 635, ATTO 637, ATTO 647, ATTO 647N, ATTO 655, ATTO 665, ATTO 680, ATTO 700, ATTO 725, ATTO 740), BODIPY® (Molecular Probes, Inc., Eugene, Oreg.) dyes (BODIPY FL, BODIPY R6G, BODIPY TMR, BODIPY 530/550, BODIPY 558/568, BODIPY 564/570, BODIPY 576/589, BODIPY 581/591, BODIPY 630/650, BODIPY 650/665), HiLyte F1uor™ (AnaSpec, Fremont, Calif.) dyes (HiLyte Fluor 488, HiLyte Fluor 555, HiLyte Fluor 594, HiLyte Fluor 647, HiLyte Fluor 680, HiLyte Fluor 750), AMCA, AMCA-S, Cascade® Blue (Molecular Probes, Inc., Eugene, Oreg.), Cascade Yellow, Coumarin, Hydroxycoumarin, Rhodamine Green™-X (Molecular Probes, Inc., Eugene, Oreg.), Rhodamine Red™-X (Molecular Probes, Inc., Eugene, Oreg.), Rhodamine 6G, TMR, ABY™ (Applied Biosystems, Carlsbad, Calif.), TAMRA™ (Applied Biosystems, Carlsbad, Calif.), 5-TAMRA, 4,7-dlchlorotetramethyl rhodamine (DTAMRA), JUN™ (Applied Biosystems, Carlsbad, Calif.), ROX™ (Applied Biosystems, Carlsbad, Calif.), Oregon Green® (Life Technologies, Grand Island, N.Y.), Oregon Green 500, IRDye® 700 (Li-Cor Biosciences, Lincoln, Nebr.), IRDye 800, WeIIRED D2, WeIIRED D3, WeIIRED D4, and Lightcycler® 640 (Roche Diagnostics GmbH, Mannheim, Germany).

Fluorophores used as labels to generate a fluorescently labeled probe included in embodiments of methods and compositions of the present invention can be any of numerous fluorophores including, but not limited to, 4-acetamido-4′-isothiocyanatostilbene-2,2′disulfonic acid; acridine and derivatives such as acridine and acridine isothiocyanate; 4-amino-N-[3-vinylsulfonyl)phenyl]naphthalimide-3,5 disulfonate, Lucifer Yellow VS; N-(4-anilino-1-naphthyl)maleimide; anthranilamide, Brilliant Yellow; BIODIPY fluorophores (4,4-difluoro-4-bora-3a,4a-diaza-s-indacenes); coumarin and derivatives such as coumarin, 7-amino-4-methylcoumarin (AMC, Coumarin 120), 7-amino-4-trifluoromethylcoumarin (Coumarin 151); cyanosine; DAPDXYL sulfonyl chloride; 4′,6-diaminidino-2-phenylindole (DAPI); 5′,5″-dibromopyrogallol-sulfonephthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-4′-dimethylaminophenylazo)benzoic acid (DABCYL); 4-dimethylaminophenylazophenyl-4′-isothiocyanate (DABITC); EDANS (5-[(2-aminoethyl)amino]naphthalene-1-sulfonic acid), eosin and derivatives such as eosin isothiocyanate; erythrosin and derivatives such as erythrosin B and erythrosin isothiocyanate; ethidium such as ethidium bromide; fluorescein and derivatives such as 5-carboxyfluorescein (FAM), hexachlorofluorescenin, 5-(4,6-dichlorotriazin-2-yl)aminofluorescein (DTAF), 2′,7′-dimethoxy-4′,5′-dichloro carboxyfluorescein (JOE) and fluorescein isothiocyanate (FITC); fluorescamine; green fluorescent protein and derivatives such as EBFP, EBFP2, ECFP, and YFP; IAEDANS (5-({2-[(iodoacetyl)amino]ethyl} amino)naphthalene-1-sulfonic acid), Malachite Green isothiocyanate; 4-methylumbelliferone; orthocresolphthalein; nitrotyrosine; pararosaniline; Phenol Red; B-phycoerytnin; o-phthaldialdehyde; pyrene and derivatives such as pyrene butyrate, 1-pyrenesulfonyl chloride and succinimidyl 1-pyrene butyrate; QSY 7; QSY 9; Reactive Red 4 (Cibacron® Brilliant Red 3B-A); rhodamine and derivatives such as 6-carboxy-X-rhodamine (ROX), 6-carboxyrhodamine (Rhodamine 6G), rhodamine isothiocyanate, lissamine rhodamine B sulfonyl chloride, rhodamine B, rhodamine 123, sulforhodamine B, sulforhodamine 101 and sulfonyl chloride derivative of sulforhodamine 101 (Texas Red); N,N,N′,N-tetramethyl-carboxyrhodamine (TAMRA); tetramethyl rhodamine; tetramethyl rhodamine isothiocyanate (TRITC); riboflavin; rosolic acid; and terbium chelate derivatives.

In certain embodiments, the fluorescent moiety can comprise a fluorescent protein, such as, for example, a green fluorescent protein (GFP); a modified derivative of GFP, including, for example, a GFP comprising S65T, an enhanced GFP; blue fluorescent protein, including, for example, EBFP, EBFP2, Azurite, and mKalamal; cyan fluorescent protein, such as, for example, ECFP, Cerulean, CyPet, mTurquoise2; and yellow fluorescent protein derivatives such as, for example, YFP, Citrine, Venus, YPet. Embodiments provide that the fluorescent protein may be covalently or noncovalently bonded to one or more query probes, analytes, and/or capture probes. In some embodiments, the label is a fluorescently detectable moiety as described in, Haugland (September 2005) MOLECULAR PROBES HANDBOOK OF FLUORESCENT PROBES AND RESEARCH CHEMICALS (10th ed.), which is herein incorporated by reference in its entirety.

In certain embodiments, dyes ranging between 500 nm to 700 nm have the advantage of being in the visible spectrum and can be detected using existing photomultiplier tubes. In some embodiments, the broad range of available dyes allows selection of dye sets that have emission wavelengths that are spread across the detection range. Detection systems capable of distinguishing many dyes are known in the art.

In certain embodiments, the subject invention relates to microfluidic sample handling for surface capture of an analyte followed by detection of the analyte by an assay, such as, for example, a SiMREPS assay. In certain embodiments, the methods comprise providing a microfluidic microplate disclosed herein comprising controlled channel or well dimensions as disclosed herein; providing a sample comprising an analyte; and contacting the sample comprising the analyte in a microfluidic microplate, as disclosed herein, comprising a small capture area coated with a capture probe. In some embodiments, the technology maximizes the fraction such as, for example, at least 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, 99.5%, or more of the analyte that can be immobilized within the capture area.

In certain embodiments, the subject invention can comprise cyclically reloading fresh aliquots of the analyte sample or the same aliquot of the analyte sample into the microfluidic microplate, as disclosed herein. In certain embodiments, fresh aliquots of the analyte sample can be added to the disclosed microfluidic microplate at specified time intervals, such as, for example, at intervals of approximately every about 1 second to about 10 minutes, every about 10 seconds to about 8 minutes, every about 30 seconds to about 7 minutes, every about 1 minute to about 6 minutes, every about 1 minute to about 5 minutes, or every about 1 minute to about 4 minutes, every about 1 minute to about 3 minutes, or every about 1 minute to about 2 minutes. In certain embodiments, between the introductions of each aliquot of analyte sample, the capture area within the device can be purged of the previous aliquot. Purging can be performed by washing the capture area with a buffer or other solution that does not comprise analyte or by pumping air or another gas such as nitrogen through the capture area of the disclosed microfluidic microplate. The purge time can be about one second (or less), up to about 30 to about 60 seconds or 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 seconds. In certain embodiments, the technology comprises cyclically reloading the same aliquot of the analyte sample into the device multiple. In these embodiments, an aliquot of the analyte sample is introduced into the microfluidic microplate disclosed herein and purged. After purging the capture area, the same aliquot of the analyte sample can then be re-loaded into the capture area of the microfluidic device.

In certain embodiments, the technology comprises mixing the analyte sample within the microfluidic microplate disclosed herein for example, within the capture area of the disclosed microfluidic microplate. In certain embodiments, the mixing can be active or passive mixing. Passive mixing can be achieved by altering the structure or configuration of fluid channels or wells and can be incorporated into the disclosed microfluidic microplate system. The extent of mixing can be determined by the device configuration and can be adjusted by using sample flow rates. In some embodiments, slanted wells, well pitch, charged walls, ridges, herringbone patterns, and/or grooves in the channel(s) of the microfluidic microplate can affect the mixing.

In certain embodiments, the analyte sample can be actively mixed within of the microfluidic microplate disclosed herein. In some embodiments, microstirrers, acoustic waves, microbubbles, periodic fluid pulsation, thermal mixing, electrokinetic mixing, or combination thereof can be used to mix the analyte sample. In certain embodiments, any combination of active and passive mixing can be used.

In certain embodiments, systems can comprise analytical processes, such as, for example, embodied in a set of instructions that can be encoded by software to direct a microprocessor to perform the analytical processes in order to identify an individual molecule of the analyte. In certain embodiments, analytical processes use the timing of repeated binding and dissociation events to said analyte as input data.

In certain embodiments, a fluorescence microscope can be used in the detection and analysis methods by configuring said microscope to excite bound query probes, such as, for example, a prism-type total internal reflection fluorescence (TIRF) microscope, an objective-type TIRF microscope, a near-TIRF or HiLo microscope, a confocal laser scanning microscope, a zero-mode waveguide, and/or an illumination configuration capable of parallel monitoring of a large area of the microfluidic microplate disclosed herein while restricting illumination to a small region, such as, for example, an individual well or a portion of an individual well, such as, for example less than about 50%, less than about 40%, less than about 30%, less than about 20%, less than about 10%, or less than about 1% of the well. In certain embodiments, the microscope or other detecting device can be configured to move the detecting region from one well to the next single well or from at least two wells to the next set of at least two wells. In certain embodiments, a fluorescence detector can be used, including, for example, a detector comprising an intensified charge coupled device (ICCD), an electron-multiplying charge coupled device (EM-CCD), a complementary metal-oxide-semiconductor (CMOS), a photomultiplier tube (PMT), an avalanche photodiode (APD), and/or another detector capable of detecting fluorescence emission from single chromophores. In certain embodiments, lens-free imaging can be used, including, for example, a lens-free microscope, which can be a detection and/or imaging component for directly imaging on a detector, such as, for example, a CMOS without using a lens. In certain embodiments, optics, such as, for example, lenses, mirrors, dichroic mirrors, or optical filters, can be used to detect fluorescence selectively within a specific range of wavelengths or multiple ranges of wavelengths. In certain embodiments, a computer can perform various methods. In certain embodiments, a computer processor can execute one or more sequences of one or more instructions contained in the memory of the computer. In certain embodiments, steps of the described methods can be implemented in software code, encoded in a programming language such as, for example, BASIC, NeXTSTEP, C, C++, C#, Objective C, Java, MATLAB, Mathematica, Perl, PHP, Ruby, Scala, Lisp, Smalltalk, Python, Swift, or R.

In certain embodiments, a step of a method or series of method steps described herein can be provided as an object method. In certain embodiments, data and/or a data structure described herein is provided as an object data structure and/or an object-oriented pipeline for processing data.

In certain embodiments, the system can comprise a microfluidic microplate disclosed herein, a processor, a memory, and/or a database for storing and executing instructions, analyzing fluorescence, image data, performing calculations using the data, transforming the data, and storing the data. In certain embodiments, an algorithm can be used to apply a statistical model to the data. In certain embodiments, cloud computing can be used to provide a virtual computer system that comprises the components and/or performs the functions of a computer as described herein.

In certain embodiments, an equation comprising variables representing the presence, absence, concentration, amount, or sequence properties of one or more analytes can produce a value for use in a diagnosis or assessing the presence or qualities of an analyte. In certain embodiments, a device stores the value, transmits the value, or uses the value for additional calculations. The value for use in a diagnosis or assessing the presence or qualities of an analyte can be received, processed, and/or transmitted to and from laboratories conducting the assays, information providers, medical personal, and/or subjects. Once received by the provider, medical personal, and/or subjects, the sample can be processed and a profile can be produced that is specific for the diagnostic or prognostic information desired for the subject. The profile data are then prepared in a format suitable for interpretation by a treating clinician or for research purposes.

### Example

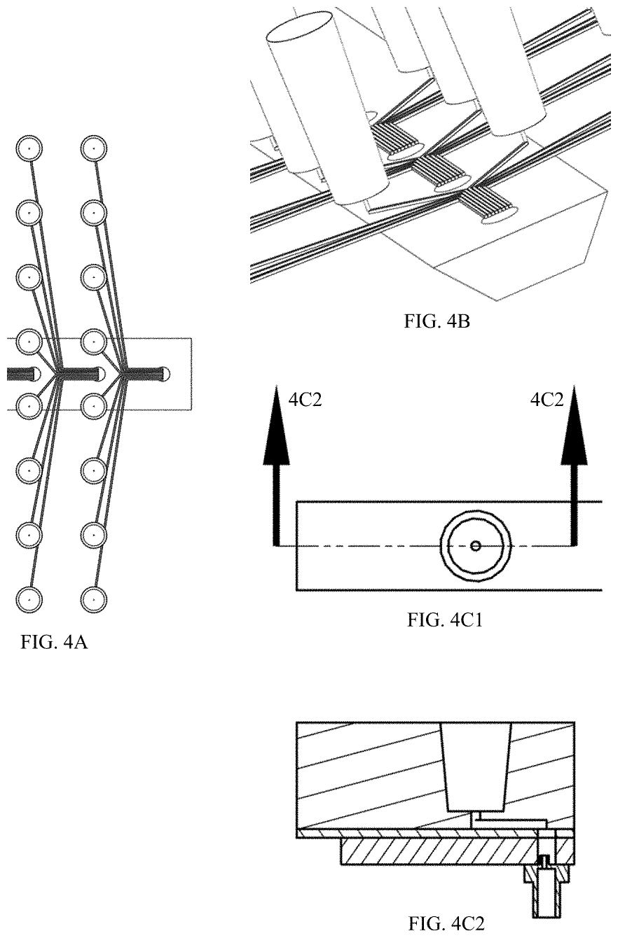

Below is provided an exemplary assay protocol for protein SiMREPS for a device as illustrated in FIG. 4. A similar assay can be used for the device as illustrated in FIG. 5 in which a 4-plex assay is performed. The assay can be conducted with a variety of capture antibodies (capAb or binding agents), analytes (antigens (Ag(s)), and detection antibodies (DetAb, detection agents, or query probes).

1. Load samples (Ag, DetAb) into all wells; insert plate into instrument.

2. Apply vacuum to port at bottom of prism to simultaneously initiate flow and fill 8 channels from column 1 wells. Wait ˜18 min to allow antibodies/antigen to bind to activated surface on coverglass beneath channel bundle. Initiate flow for other columns of samples every 6 min for equal binding times.

3. Position Col 1 channel bundle above objective lens and perform prism TIRF×2 min at for example 30-37° C.

4. Optionally, increment plate a couple mm along channel length to image FOVs 2 and 3 for improved sensitivity and obtaining technical replicates for each sample.

Repeat steps 3 and 4 for all columns of samples.

We claim:

1. A microfluidic microplate comprising two or three layers, said microfluidic microplate comprising:
a) a two layer microfluidic microplate comprising a top layer (Layer 1) that comprises a plurality of wells on the top face of the layer, each well having an opening that is fluidly connected to microfluidic channels that are integrated into the lower portion of the top layer or the upper layer or upper surface of the second layer (Layer 2) that comprises a planar surface comprising imaging zones, a prism on the lower surface of Layer 2, and an exit port that is provided in Layer 1 and/or Layer 2;
b) a two layer microfluidic microplate comprising a top layer (Layer 1) that comprises a plurality of wells on the top face of the layer, each well having an opening that is fluidly connected to microfluidic channels that are integrated into the lower portion of the top layer or the upper layer or upper surface of the second layer (Layer 2) that comprises a planar surface comprising imaging zones and comprises a high refractive index material as a waveguide for waveguide total internal reflection fluorescence (TIRF) microscopy, and an exit port that is provided in Layer 1 and/or Layer 2; or
c) a three layer microfluidic microplate comprising a top layer (Layer 1) that comprises a plurality of wells on the top face of the layer, each well having an opening that is fluidly connected to microfluidic channels that are integrated into the lower portion of the top layer (Layer 1) or the upper layer or upper surface of a middle layer (Layer 2), and a third layer (Layer 3) that comprises a prism which is attached to the lower surface of Layer 2 and an exit port that is provided in Layer 2 and/or Layer 3; wherein:
two or more of the microfluidic channels converge on an imaging zone found on the upper surface of the second layer of the microplate thereby fluidly connecting each well with the imaging zone and each imaging zone being functionalized for the attachment of a binding agent for an analyte or having one or more binding agent attached thereto.

2. The microfluidic microplate according to claim 1, wherein the microfluidic channels converge on the imaging zone from two (2), three (3), four (4), five (5), six (6), seven (7), eight (8), or more wells.

3. The microfluidic microplate according to claim 1, wherein the microfluidic channels are constricted or treated with:
a) a hydrophobic material to prevent the flow of fluid from one or more wells in the absence of a vacuum; or
b) a hydrophilic material that draws fluid from one or more wells into the imaging zone in the absence of a vacuum.

4. The microfluidic microplate according to claim 3, wherein the microfluidic channels are treated with:
a) a hydrophobic material selected from polytetrafluoroethylene (PTFE), fluorinated ethylene propylene (FEP), silanes comprising one or more hydrocarbon group, perfluoroalkoxy (PFA), or combinations thereof; or
b) a hydrophilic material selected from polyethylene glycol (PEG), polyacrylamide, poly(vinyl alcohol) (PVA), hydroxylethylcellulose (HEC), poly(N-hydroxyethyl acrylamide) (PHEA), hydroxylpropyl methylcellulose (HPMC), poly(-hydroxyethyl methacrylate) (pHEMA), poly(vinyl pyrrolidone) (PVP), poly(acrylic acid) (PAA), dextran, hyaluronic acid, poly(-methacryloyloxyethyl phosphorylcholine) (PMPC), or combinations thereof.

5. The microfluidic microplate according to claim 1, wherein the microfluidic channels connecting each column of wells to an imaging zone have equal length.

6. The microfluidic microplate according to claim 1, wherein the microfluidic channels are linear, nonlinear, serpentine, helical or a combination thereof.

7. The microfluidic microplate according to claim 1, wherein the imaging zones are functionalized with:
a) a functionalization agent comprising a carboxyl, amine, thiol, or hydroxyl functional group;
b) a self-assembling functional agent selected from n-octadecyltrichlorosilane, 11-bromo undecyltrichlorosilane, 1H, 1H,2H,2H-perfluoro-decyltrichlorosilane, N-[3-(trimethoxysilyl)propyl]-ethylenediamine, (3-aminopropyl)trimethoxy-silane, (3-aminopropyl)triethoxysilane, (3-mercaptpropyl)trimethoxysilane, PEG silanes (having a trichlorosiloxane, trimethoxysiloxane, or triethoxysiloxane functional group), N-(6-aminohexyl)-3-aminopropyltrimethoxysilane, phenyltrichlorosilane, benzyltrichlorosilane, n-octadecyltrimethoxysilane, heptadecafluoro-1,1,2,2-tetrahydro-decyl-1-trimethoxy-silane, 3,3,3-trifluoropropyltrimethoxysilane, (4-chloromethyl)phenyltrimethoxysilane, 18-nonadecenyltrichlorosilane, 2,2,2-trifluoroethyl undec-10-enoate and combinations thereof;
c) a functionalization agent comprising a silane group that binds to a surface of the imaging zone and a free hydroxyl group, thiol group, mercapto groups, carboxyl group, or amine group;
d) a functionalization agent selected from N-(3-triethoxysilylpropyl)-4-hydroxybutyramide (HAPS), 11-acetoxyundecyltriethoxysilane, n-decyltriethoxysilane, (3-aminopropyl)trimethoxysilane, (3-aminopropyl)triethoxysilane, 3-glycidoxypropyltrimethoxysilane (GOPS), 3-iodo-propyltrimethoxysilane, butyl-aldehydr-trimethoxysilane; dimeric secondary aminoalkyl siloxanes; aminosilanes such as (3-aminopropyl)-triethoxysilane, (3-aminopropyl)-di ethoxy-m ethyl silane, (3-aminopropyl)-dimethyl-ethoxysilane, (3-aminopropyl)-trimethoxysilane, glycidoxysilanes, (3-glycidoxypropyl)-dimethyl-ethoxysilane glycidoxy-trimethoxysilane, mercaptosilanes, (3-mercaptopropyl)-trimethoxysilane, 3-4 epoxycyclohexyl-ethyltrimethoxysilane, (3-mercaptopropyl)-methyl-dimethoxysilane, siloxanes, hy droxy alkyl siloxanes, and combinations thereof; and/or
e) a binding agent binding an analyte selected from antibodies, aptamer, nucleic acid sequences, enzymes, hormones, interleukins, chemokines, growth regulators, clotting factors, phosphoproteins, immunogens, polysaccharides, toxins, cell walls, cell capsules, viral capsules, viral coats, flagellae, fimbriae, pili, microorganisms, lipids, molecules associated with, or present in, bodily fluids from mammals, or combinations thereof.

8. The microfluidic microplate according to claim 7, wherein the imaging zone is functionalized with one or more binding agent that binds an analyte selected from antibodies, aptamers, nucleic acid sequences, enzymes, hormones, interleukins, chemokines, growth regulators, clotting factors, phosphoproteins, immunogens, polysaccharides, toxins, cell walls, cell capsules, viral capsules, viral coats, flagellae, fimbriae, pili, microorganisms, lipids, molecules associated with, or present in, bodily fluids from mammals, or combinations thereof

9. The microfluidic microplate according to claim 8, wherein the imaging zone is functionalized with two or more binding agent that binds an analyte selected from antibodies, aptamers, nucleic acid sequences, enzymes, hormones, interleukins, chemokines, growth regulators, clotting factors, phosphoproteins, immunogens, polysaccharides, toxins, cell walls, cell capsules, viral capsules, viral coats, flagellae, fimbriae, pili, microorganisms, lipids, molecules associated with, or present in, bodily fluids from mammals, or combinations thereof.

10. The microfluidic microplate according to claim 1, wherein the microfluidic microplate comprises at least one port for the attachment of a vacuum source.

11. The microfluidic microplate according to claim 9, wherein the two or more binding agents are printed onto the imaging zone, optionally at addressable locations.

12. The microfluidic microplate according to claim 1, wherein the imaging zones are aligned linearly.

13. The microfluidic microplate according to claim 1, wherein the imaging zones comprise a thermal control device that regulates the temperature of the imaging zone.

14. The microfluidic microplate according to claim 1, wherein the microfluidic microplate comprises a prism, said prism comprising a material selected from the group consisting of a glass, borosilicate glass, fused silica, silicon nitride, tantalum pentoxide, plastic, and combinations thereof, said material having a refractive index of about 1.5, at least 1.5, or about 1.5 and about 1.9.

15. The microfluidic microplate according to claim 1, the microfluidic microplate comprising a two layer microfluidic microplate comprising a top layer (Layer 1) that comprises a plurality of wells on the top face of the layer, each well having an opening that is fluidly connected to microfluidic channels that are integrated into the lower portion of the top layer or the upper layer or upper surface of the second layer (Layer 2) that comprises a planar surface comprising imaging zones and comprises a high refractive index material as a waveguide for waveguide total internal reflection fluorescence (TIRF) microscopy, and an exit port that is provided in Layer 1 and/or Layer 2, the imaging zones being deposited on the high refractive index material.

16. The microfluidic microplate according to claim 15, wherein the high refractive index material comprises a material selected from the group consisting of a glass, borosilicate glass, fused silica, silicon nitride, tantalum pentoxide, plastic, and combinations thereof, said material having a refractive index of about 1.5, at least 1.5, or between about 1.5 and abount 1.9.

17. A system for detecting an analyte, said system comprising:
a capture probe that stably binds the analyte;
a query probe that transiently binds to the analyte; and
a microfluidic microplate, according to claim 1 that comprises a substrate and a capture area in which the capture probe is immobilized.

18. A method to detect and/or quantify an analyte in a sample comprising:
i) providing a system according to claim 17;
ii) providing the sample containing the analyte; and
iii) detecting and/or quantifying the analyte in the sample.
